(19) United States
(12) Patent Application Publication
(10) Pub. No.: US 2022/0276720 A1
(43) Pub. Date: Sep. 1, 2022

(54) GESTURE RECOGNITION APPARATUS, MOBILE OBJECT, GESTURE RECOGNITION METHOD, AND STORAGE MEDIUM

(71) Applicant: HONDA MOTOR CO., LTD., Tokyo (JP)

(72) Inventor: Yuji Yasui, Wako-shi (JP)

(21) Appl. No.: 17/681,864

(22) Filed: Feb. 28, 2022

(30) Foreign Application Priority Data
Mar. 1, 2021 (JP) 2021-031630

(51) Int. Cl. G06F 3/01; G06V 40/20; G06V 40/10; G06V 10/25; G06V 10/74; G06T 7/20; G06T 7/70; G05D 1/00

(52) U.S. Cl. CPC G06F 3/017; G06V 40/28; G06V 40/10; G06V 10/25; G06V 10/761; G06T 7/20; G06T 7/70; G05D 1/0011; G06V 2201/07; G06T 2207/30196; G06T 2207/30252

(57) ABSTRACT

A gesture recognition apparatus acquires an image capturing a user, recognizes a region where the user is present when the image is captured, and in a case in which the user is present in a first region when the image is captured, recognizes a gesture of the user on the basis of the image and first information for recognizing the gesture of the user, and in a case in which the user is present in a second region when the image is captured, recognizes a gesture of the user on the basis of the image and second information for recognizing the gesture of the user.

### CROSS-REFERENCE TO RELATED APPLICATION

Priority is claimed on Japanese Patent Application No. 2021-031630, filed Mar. 1, 2021, the content of which is incorporated herein by reference.

### BACKGROUND

### Field

The present invention relates to a gesture recognition apparatus, a mobile object, a gesture recognition method, and a storage medium.

### Description of Related Art

In the related art, robots that guide users to desired locations or transport baggage are known. For example, a mobile robot moving within a predetermined distance from persons when services as described above are provided has been disclosed (Japanese Patent No. 5617562).

### SUMMARY

However, the aforementioned technique may not provide sufficient user convenience.

The present invention was made in consideration of such circumstances, and an object thereof is to provide a gesture recognition apparatus, a mobile object, a gesture recognition method, and a storage medium capable of improving user convenience.

The gesture recognition apparatus, the mobile object, the gesture recognition method, and the storage medium according to the invention employ the following configurations.

(1): A gesture recognition apparatus includes: a storage device configured to store instructions; and one or more processors, and the one or more processors execute the instructions stored in the storage device to acquire an image capturing a user, recognize a region where the user is present when the image is captured, and in a case in which the user is present in a first region when the image is captured, recognize a gesture of the user on the basis of the image and first information for recognizing the gesture of the user, and in a case in which the user is present in a second region when the image is captured, recognize a gesture of the user on the basis of the image and second information for recognizing the gesture of the user.

(2): In the aforementioned aspect (1), the first region is a region within a range of a predetermined distance from an imaging device that captures the image, and the second region is a region set at a position further than the predetermined distance from the imaging device.

(3): In the aforementioned aspect (1) or (2), the first information is information for recognizing a gesture that does not include a motion of an arm, include a motion of the hand or fingers, and is achieved by a motion of the hand or the fingers.

(4): In any of the aforementioned aspects (1) to (3), the second information is information for recognizing a gesture that includes a motion of an arm.

(5): In the aforementioned aspect (4), the first region is a region in which it is not possible or difficult to recognize the motion of the arm of the user from the image capturing the user who is present in the first region through execution of the instructions by the one or more processors. (6): In any of the aforementioned aspects (1) to (5), the one or more processors execute the instructions to recognize a gesture of the user on the basis of the image, the first information, and the second information in a case in which the user is present in a third region which is located across the first region and a second region that is outside the first region and is adjacent to the first region or a third region located between the first region and a second region that is located further than the first region.

(7): In the aforementioned aspect (6), the one or more processors execute the instructions to recognize a gesture of the user by placing higher priority on a result of recognition based on the image and the first information than on a result of recognition based on the image and the second information in a case in which the gesture of the user is recognized on the basis of the image, the first information, and the second information.

(8): A mobile object includes: the gesture recognition system according to any of the aforementioned aspects (1) to (7).

(9): In the aforementioned aspect (8), the mobile object further includes: a storage device storing reference information in which a gesture of the user and an operation of the mobile object are associated; and a controller configured to control the mobile object on the basis of the operation of the mobile object associated with the gesture of the user with reference to the reference information.

(10): In the aforementioned aspect (9), the mobile object further includes: a first imager configured to image surroundings of the mobile object; and a second imager configured to image a user who remotely operates the mobile object, and the one or more processors execute the instructions to attempt processing for recognizing a gesture of the user on the basis of a first image captured by the first imager and a second image captured by the second imager and employ, with higher priority, a result of the recognition based on the second image than a result of the recognition on the basis of the first image, and cause the mobile object to be controlled on the basis of a surrounding situation obtained from the image captured by the first imager and the operation associated with the gesture recognized by the recognizer.

(11): In any of the aforementioned aspects (8) to (10), the mobile object further includes: a first imager configured to image surroundings of the mobile object; and a second imager configured to image a user who remotely operates the mobile object, and the one or more processors execute the instructions to recognize a gesture of the user on the basis of a second image captured by the second imager with reference to the first information in a case in which the user is present in a first region and it is not possible to recognize the gesture of the user on the basis of a first image captured by the first imager, and cause the mobile object to be controlled on the basis of an image captured by the first imager in accordance with the gesture recognized by the recognizer.

(12): In any of the aforementioned aspects (8) to (11), the one or more processors execute the instructions to track a user as a target on the basis of a captured image, recognize a gesture of the user who is being tracked, and not perform processing for recognizing gestures of persons who are not being tracked, and control the mobile object on the basis of the gesture of the user who is being tracked.

(13): A gesture recognition method according to an aspect of the invention includes, by a computer, acquiring an image capturing a user; recognizing a region where the user is present when the image is captured; and in a case in which the user is present in a first region when the image is captured, recognizing a gesture of the user on the basis of the image and first information for recognizing the gesture of the user; and in a case in which the user is present in a second region when the image is captured, recognizing a gesture of the user on the basis of the image and second information for recognizing the gesture of the user.

(14): A non-transitory computer storage medium storing instructions causes a computer to execute: acquiring an image capturing a user; recognizing a region where the user is present when the image is captured; and in a case in which the user is present in a first region when the image is captured, recognizing a gesture of the user on the basis of the image and first information for recognizing the gesture of the user; and in a case in which the user is present in a second region when the image is captured, recognizing a gesture of the user on the basis of the image and second information for recognizing the gesture of the user.

According to (1) to (14), it is possible to improve user convenience by the recognizer recognizing the gesture using the first information or the second information in accordance with the position of the user.

According to (6), the gesture recognition apparatus can further accurately recognize the gesture through recognition of the gesture using the first information and the second information.

According to (8) to (11), the mobile object can perform operations that reflect user's intention. For example, the user can easily cause the mobile object to operate through a simple indication.

According to (10) or (11), the mobile object performs an operation in accordance with the gesture recognized on the basis of the images acquired by the camera configured to acquire the image for recognizing the surroundings and the camera for a remote operation and can thus further accurately recognize the gesture and further perform operations in accordance with a user's intention.

According to (12), the mobile object tracks the user to which a service is being provided and performs processing by paying attention to the gesture of the user who is the tracking target and can thus improve user convenience while reducing a processing load.

### BRIEF DESCRIPTION OF THE DRAWINGS

FIG. 1 is a diagram showing an example of a mobile object including a control device according to an embodiment.

FIG. 2 is a diagram showing an example of functional configurations included in a main body of the mobile object.

FIG. 3 is a diagram showing an example of a trajectory.

FIG. 4 is a flowchart showing an example of a tracking processing flow.

FIG. 5 is a diagram showing processing for extracting features of a user and processing for registering the features.

FIG. 6 is a diagram showing processing in which a recognizer tracks the user.

FIG. 7 is a diagram showing tracking processing using features.

FIG. 8 is a diagram showing processing for specifying the user who is a tracking target.

FIG. 9 is a diagram showing another example of the processing in which the recognizer tracks the user.

FIG. 10 is a diagram showing processing for specifying the user who is a tracking target.

FIG. 11 is a flowchart showing an example of action control processing flow.

FIG. 12 is a diagram showing processing for recognizing a gesture.

FIG. 13 is a diagram showing a user who is present in a first region.

FIG. 14 is a diagram showing a user who is present in a second region.

FIG. 15 is a diagram showing a second gesture A.

FIG. 16 is a diagram showing a second gesture B.

FIG. 17 is a diagram showing a second gesture C.

FIG. 18 is a diagram showing a second gesture D.

FIG. 19 is a diagram showing a second gesture E.

FIG. 20 is a diagram showing a second gesture F.

FIG. 21 is a diagram showing a second gesture G.

FIG. 22 is a diagram showing a second gesture H.

FIG. 23 is a diagram showing a first gesture a.

FIG. 24 is a diagram showing a first gesture b.

FIG. 25 is a diagram showing a first gesture c.

FIG. 26 is a diagram showing a first gesture d.

FIG. 27 is a diagram showing a first gesture e.

FIG. 28 is a diagram showing a first gesture f.

FIG. 29 is a diagram showing a first gesture g.

FIG. 30 is a flowchart showing an example of processing in which a control device 50 recognizes a gesture.

FIG. 31 is a diagram (part 1) showing a third region.

FIG. 32 is a diagram (part 2) showing the third region.

FIG. 33 is a diagram showing an example of functional configurations in a main body of a mobile object according to a second embodiment.

FIG. 34 is a flowchart showing an example of a processing flow executed by a control device according to the second embodiment.

FIG. 35 is a diagram showing a modification example of the second gesture G.

FIG. 36 is a diagram showing a modification example of the second gesture H.

FIG. 37 is a diagram showing a modification example of the second gesture F.

FIG. 38 is a diagram showing a second gesture FR.

FIG. 39 is a diagram showing a second gesture FL.

### DETAILED DESCRIPTION

Hereinafter, a gesture recognition apparatus, a mobile object, a gesture recognition method, and a storage medium according to embodiments of the present invention will be described with reference to the drawings. As used throughout this disclosure, the singular forms “a”, “an”, and “the” include a plurality of references unless the context clearly dictates otherwise.

### First Embodiment

### [Overall Configuration]

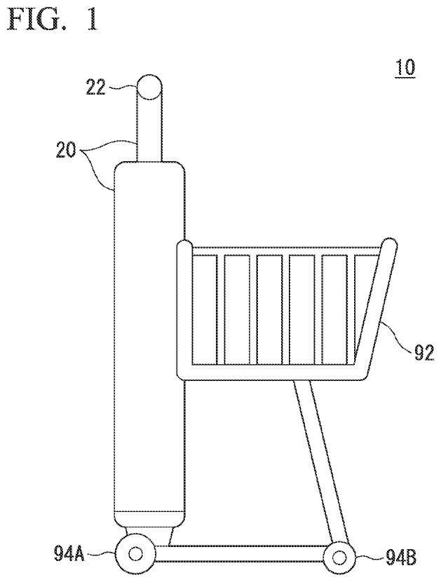

FIG. 1 is a diagram showing an example of a mobile object 10 including a control device according to an embodiment. The mobile object 10 is an autonomous mobile robot. The mobile object 10 assists user's actions. For example, the mobile object 10 assists shopping or customer services for customers in accordance with a shop staff member, a customer, a facility staff member (hereinafter, these persons will be referred to as “users”), or the like or assists operations of a staff member.

The mobile object 10 includes a main body 20, a housing 92, and one or more wheels 94 (wheels 94A and 94B in the drawing). The mobile object 10 moves in accordance with an indication based on a gesture or sound of a user, an operation performed on an input unit (a touch panel, which will be described later) of the mobile object 10, or an operation performed on a terminal device (a smartphone, for example). The mobile object 10 recognizes a gesture on the basis of an image captured by a camera 22 provided in the main body 20, for example.

For example, the mobile object 10 causes the wheels 94 to be driven and moves to follow a customer in accordance with movement of the user or moves to lead the customer. At this time, the mobile object 10 explains items or operations for the user or guides the user to items or targets that the user is searching for. The user can accommodate items to be purchased and baggage in the housing 92 adapted to accommodate these.

Although the present embodiment will be described on the assumption that the mobile object 10 includes the housing 92, alternatively (or additionally), the mobile object 10 may be provided with a seat portion in which the user is seated to move along with the mobile object 10, a casing in which the user gets, steps on which the user places his/her feet, and the like. For example, the moving object may be scooter.

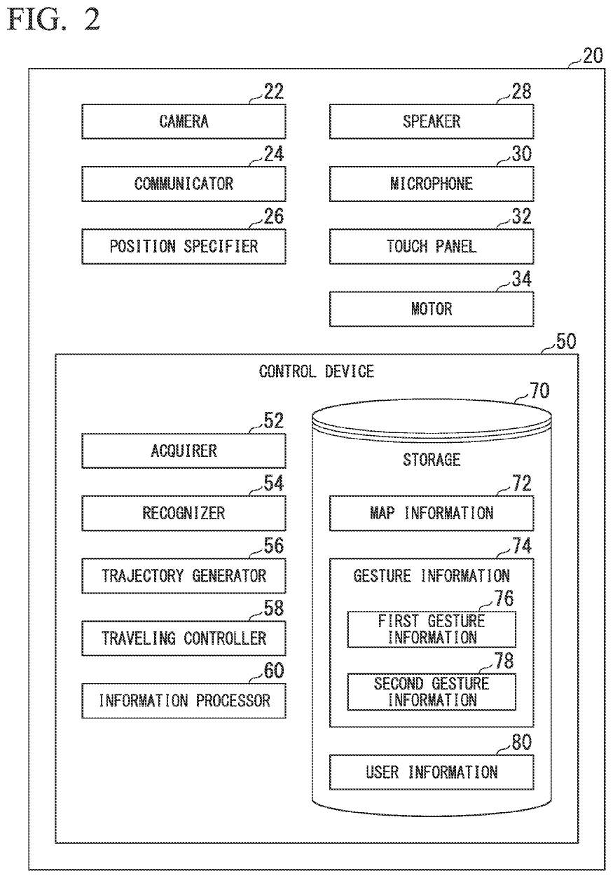

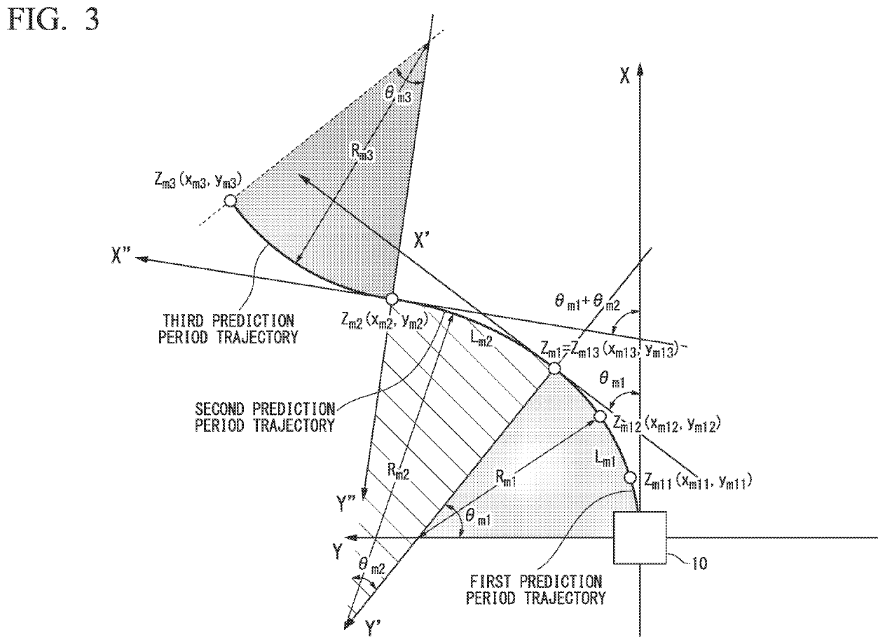

FIG. 2 is a diagram showing an example of functional configurations included in the main body 20 of the mobile object 10. The main body 20 includes the camera 22, a communicator 24, a position specifier 26, a speaker 28, a microphone 30, a touch panel 32, a motor 34, and a control device 50.

The camera 22 images the surroundings of the mobile object 10. The camera 22 is a fisheye camera capable of imaging the surroundings of the mobile object 10 at a wide angle (at 360 degrees, for example). The camera 22 is attached to an upper portion of the mobile object 10, for example, and images the surroundings of the mobile object 10 at a wide angle in the horizontal direction. The camera 22 may be realized by combining a plurality of cameras (a plurality of cameras configured to image a range of 120 degrees or a range of 60 degrees in the horizontal direction). The mobile object 10 may be provided with not only one camera 22 but also a plurality of cameras 22.

The communicator 24 is a communication interface that communicates with other devices using a cellular network, a Wi-Fi network, Bluetooth (registered trademark), a dedicated short range communication (DSRC), or the like.

The position specifier 26 specifies the position of the mobile object 10. The position specifier 26 acquires position information of the mobile object 10 using a global positioning system (GPS) device (not shown) incorporated in the mobile object 10. The position information may be, for example, two-dimensional map information or latitude/longitude information.

The speaker 28 outputs predetermined sound, for example. The microphone 30 receives inputs of sound generated by the user, for example.

The touch panel 32 is constituted by a display device such as a liquid crystal display (LCD) or an organic electroluminescence (EL) and an input unit capable of detecting a touch position of an operator using a coordinate detection mechanism with the display device and the input unit overlapping each other. The display device displays a graphical user interface (GUI) switch for operations. The input unit generates an operation signal indicating that a touch operation has been performed on the GUI switch and outputs the operation signal to the control device 50 when a touch operation, a flick operation, a swipe operation, or the like on the GUI switch is detected. The control device 50 causes the speaker 28 to output sound or causes the touch panel 32 to display an image in accordance with an operation. The control device 50 may cause the mobile object 10 to move in accordance with an operation.

The motor 34 causes the wheels 94 to be driven and causes the mobile object 10 to move. The wheels 94 include a driven wheel that is driven by the motor 34 in a rotation direction and a steering wheel that is a non-driven wheel driven in a yaw direction, for example. The mobile object 10 can change the traveling path and turn through adjustment of an angle of the steering wheel.

Although the mobile object 10 includes the wheels 94 as a mechanism for realizing movement in the present embodiment, the present embodiment is not limited to the configuration. For example, the mobile object 10 may be a multi-legged walking robot.

The control device 50 includes, for example, an acquirer 52, a recognizer 54, a trajectory generator 56, a traveling controller 58, an information processor 60, and a storage 70. Some or all of the acquirer 52, the recognizer 54, the trajectory generator 56, the traveling controller 58, and the information processor 60 are realized by a hardware processor such as a central processing unit (CPU), for example, executing a program (software). Some or all of these functional units may be realized by hardware (a circuit unit; including a circuitry) such as a large scale integration (LSI), an application specific integrated circuit (ASIC), a field-programmable gate array (FPGA), or a graphics processing unit (GPU) or may be realized by cooperation of software and hardware. The program may be stored in a storage 70 (a storage device including a non-transitory storage medium) such as a hard disk drive (HDD) or a flash memory in advance or may be stored in a detachable storage medium (non-transitory storage medium) such as a DVD or a CD-ROM and may be installed through attachment of the storage medium to a drive device. The acquirer 52, the recognizer 54, the trajectory generator 56, the traveling controller 58, or the information processor 60 may be provided in a device different from the control device 50 (mobile object 10). For example, the recognizer 54 may be provided in a different device, and the control device 50 may control the mobile object 10 on the basis of a result of processing performed by the different device. A part of the entirety of information stored in the storage 70 may be stored in a different device. A configuration including one or more function units out of the acquirer 52, the recognizer 54, the trajectory generator 56, the traveling controller 58, and the information processor 60 may be configured as a system.

The storage 70 stores map information 72, gesture information 74, and user information 80. The map information 72 is information in which roads and road shapes are expressed by links indicating roads or passages in a facility and nodes connected by the links, for example. The map information 72 may include curvatures of the roads and point-of-interest (POI) information.

The gesture information 74 is information in which information regarding gestures (features of templates) and operations of the mobile object 10 are associated with each other. The gesture information 74 includes first gesture information 76 (first information, reference information) and second gesture information 78 (second information, reference information). The user information 80 is information indicating features of the user. Details of the gesture information 74 and the user information 80 will be described later.

The acquirer 52 acquires an image (hereinafter, referred to as a “surrounding image”) captured by the camera 22. The acquirer 52 holds the acquired surrounding image as pixel data in a fisheye camera coordinate system.

The recognizer 54 recognizes a body motion (hereinafter, referred to as a “gesture”) of a user U on the basis of one or more surrounding images. The recognizer 54 recognizes the gesture through matching of features of a gesture of the user extracted from the surrounding images with features of a template (features indicating a gesture). The features are, for example, data representing feature locations such as fingers, finger joints, wrists, arms, and a skeleton of the person, links connecting these, inclinations and positions of the links, and the like.

The trajectory generator 56 generates a trajectory along which the mobile object 10 is to travel in the future, on the basis of the gesture of the user, a destination set by the user, objects in the surroundings, the position of the user, the map information 72, and the like. The trajectory generator 56 generates a trajectory along which the mobile object 10 can smoothly move to a target point by combining a plurality of arcs. Fig, 3 is a diagram showing an example of the trajectory. For example, the trajectory is generated by connecting three arcs. The arcs have different curvature radii Rₘ₁, Rₘ₂, and Rₘ₃, and positions of end points in prediction periods Tₘ₁, Tₘ₂, and Tₘ₃ are defined as Zₘ₁, Zₘ₂, and Zₘ₃, respectively. A trajectory (first prediction period trajectory) for the prediction period Tm1 is equally divided into three parts, and the positions are Zₘ₁₁, Zₘ₁₂, and Zₘ₁₃, respectively. The traveling direction of the mobile object 10 at a reference point is defined as an X direction, and a direction perpendicularly intersecting the X direction is defined as a Y direction. A first tangential line is a tangential line for Zₘ₁. A target point direction of the first tangential line is an X′ direction, and a direction perpendicularly intersecting the X′ direction is a Y′ direction. An angle formed by the first tangential line and a line segment extending in the X direction is θₘ₁. An angle formed by a line segment extending in the Y direction and a line segment extending in the Y′ direction is θₘ₁. A point at which the line segment extending in the Y direction and the line segment extending in the Y′ direction is a center of the arc of the first prediction period trajectory. A second tangential line is a tangential line for Zₘ₂. A target point direction of the second tangential line is an X″ direction, and a direction perpendicularly intersecting the X″ direction is a Y″ direction. An angle formed by the second tangential line and the line segment extending in the X direction is θₘ₁+θₘ₂. An angle formed by the line segment extending in the Y direction and a line segment extending in the Y″ direction is θₘ₂. A point at which the line segment extending in the Y direction and the line segment extending in the Y″ direction is a center of the arc of the second prediction period trajectory. An arc of the third prediction period trajectory is an arc passing through Zₘ₂ and Zₘ₃. The center angle of the arc is θ₃. The trajectory generator 56 may perform the calculation by fitting a state to a geometric model such as a Bezier curve, for example. For example, the trajectory is generated as a group of a finite number of trajectory points in practice.

The trajectory generator 56 performs coordinate conversion between an orthogonal coordinate system and a fisheye camera coordinate system. One-to-one relationships are established between the coordinates in the orthogonal coordinate system and the fisheye camera coordinate system, and the relationships are stored as correspondence information in the storage 70. The trajectory generator 56 generates a trajectory (orthogonal coordinate system trajectory) in the orthogonal coordinate system and performs coordinate conversion of the trajectory into a trajectory in the fisheye camera coordinate system (fisheye camera coordinate system trajectory). The trajectory generator 56 calculates a risk of the fisheye camera coordinate system trajectory. The risk is an indicator value indicating how high a probability that the mobile object 10 approaches a barrier is. The risk tends to be higher as the distance between the trajectory (trajectory points of the trajectory) and the barrier decreases, and the risk tends to be lower as the distance between the trajectory (trajectory points) and the barrier increases.

In a case in which a total value of a risk and a risk at each trajectory point satisfy preset references (the total value is equal to or less than a threshold value Th1, and the risk at each trajectory point is equal to or less than a threshold value Th2, for example), the trajectory generator 56 employs the trajectory that satisfies the references as a trajectory along which the mobile object will move.

In a case in which the aforementioned trajectory does not satisfy the preset references, the following processing may be performed. The trajectory generator 56 detects a traveling available space in the fisheye camera coordinate system and performs coordinate conversion from the detected traveling available space in the fisheye camera coordinate system into the traveling available space in the orthogonal coordinate system. The traveling available space is a space obtained by excluding regions of barriers and regions of the surroundings of the barriers (regions where risks are set or regions where the risks are equal to or greater than a threshold value) in a region in the moving direction of the mobile object 10. The trajectory generator 56 corrects the trajectory such that the trajectory falls within the range of the travel available space obtained through coordinate conversion into the orthogonal coordinate system. The trajectory generator 56 performs coordinate conversion from the orthogonal coordinate system trajectory into a fisheye camera coordinate system trajectory and calculates a risk of the fisheye camera coordinate system trajectory on the basis of the surrounding images and the fisheye camera coordinate system trajectory. The processing is repeated to search for a trajectory that satisfies the aforementioned preset reference.

The traveling controller 58 causes the mobile object 10 to travel along the trajectory that satisfies the preset reference. The traveling controller 58 outputs a command value for causing the mobile object 10 to travel along the trajectory to the motor 34. The motor 34 causes the wheels 94 to rotate in accordance with the command value and causes the mobile object 10 to move along the trajectory.

The information processor 60 controls various devices and machines included in the main body 20. The information processor 60 controls, for example, the speaker 28, the microphone 30, and the touch panel 32. The information processor 60 recognizes sound input to the microphone 30 and operations performed on the touch panel 32. The information processor 60 causes the mobile object 10 to operate on the basis of a result of the recognition.

Although the aforementioned example has been described on the assumption that the recognizer 54 recognizes a body motion of the user on the basis of an image captured by the camera 22 provided in the mobile object 10, the recognizer 54 may recognize a body motion of the user on the basis of an image captured by a camera that is not provided in the mobile object 10 (a camera that is provided at a position different from the mobile object 10). In this case, the image captured by the camera is transmitted to the control device 50 through communication, and the control device 50 acquires the transmitted image and recognizes the body motion of the user on the basis of the acquired image. The recognizer 54 may recognize a body motion of the user on the basis of a plurality of images. For example, the recognizer 54 may recognize a body motion of the user on the basis of an image captured by the camera 22 and a plurality of images captured by a camera provided at a position different from the mobile object 10. For example, the recognizer 54 may recognize a body motion of the user from each image, apply a result of the recognition to a predetermined distance, and recognize a body motion of the user, or may generate one or more images through image processing on a plurality of images and recognize a body motion intended by the user from the generated images.

### [Assist Processing]

The mobile object 10 executes assist processing for assisting shopping of the user. The assist processing includes processing related to tracking and processing related to action control.

### [Processing Related to Tracking (Part 1)]

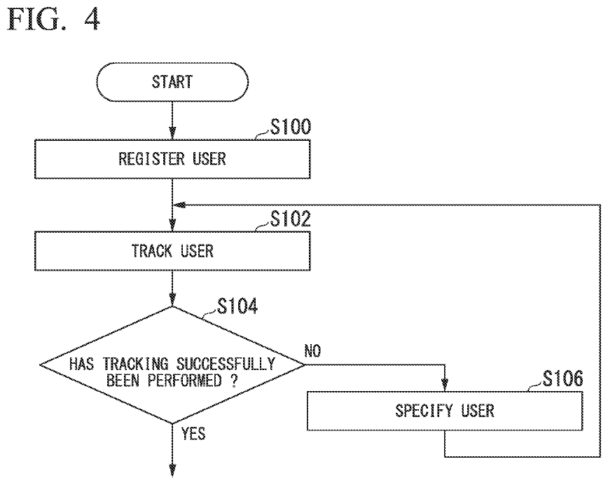

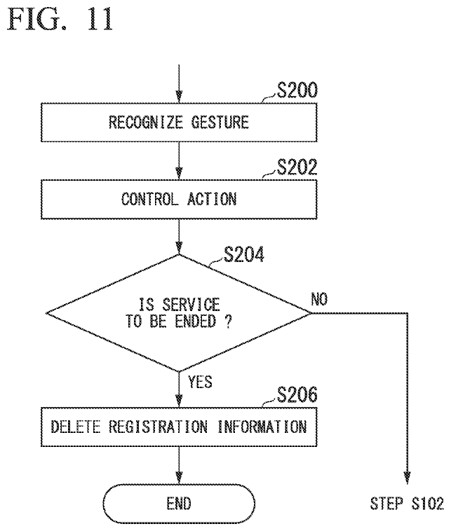

FIG. 4 is a flowchart showing an example of a tracking processing flow. First, the control device 50 of the mobile object 10 receives registration of a user (Step S100). Next, the control device 50 tracks the user registered in Step S100 (Step S102). Next, the control device 50 determines whether the tracking has successfully been performed (Step S104). In a case in which the tracking has successfully been performed, the processing proceeds to Step S200 in FIG. 11, which will be described later. In a case in which the tracking has not successfully been performed, the control device 50 specifies the user (Step S106).

### (Processing of Registering User)

The processing for registering the user in Step S100 will be described. The control device 50 of the mobile object 10 checks a registration intention of the user on the basis of a specific gesture, sound, an operation on the touch panel 32 of the user (a customer who has visited a shop, for example). In a case in which the registration intension of the user can be confirmed, the recognizer 54 of the control device 50 extracts features of the user and registers the extracted features.

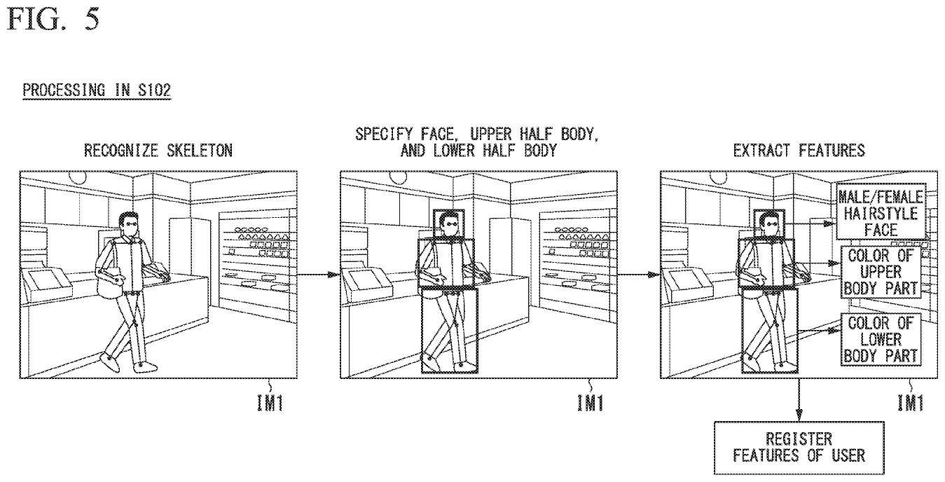

FIG. 5 is a diagram showing processing for extracting the features of the user and processing for registering the features. The recognizer 54 of the control device 50 specifies the user from an image IM1 capturing the user and recognizes joint points of the specified user (executes skeleton processing). For example, the recognizer 54 estimates a face, face parts, a neck, shoulders, elbows, wrists, a waist, ankles, and the like of the user from the image IM1 and executes skeleton processing on the basis of the position of each estimated part. For example, the recognizer 54 executes the skeleton processing using a known method (a method such as an open pose, for example) for estimating joint points or a skeleton of the user using deep learning. Next, the recognizer 54 specifies the user's face, the upper body, the lower body, and the like on the basis of the result of the skeleton processing, extracts features of the specified face, the upper body, and the lower body, and registers the extracted features as features of the user in the storage 70. The features of the face include, for example, features of male/female, a hairstyle, and a face. The features of the upper body include, for example, the color of the upper body part. The features of the lower body include, for example, the color of the lower body part.

### (Processing for Tracking User)

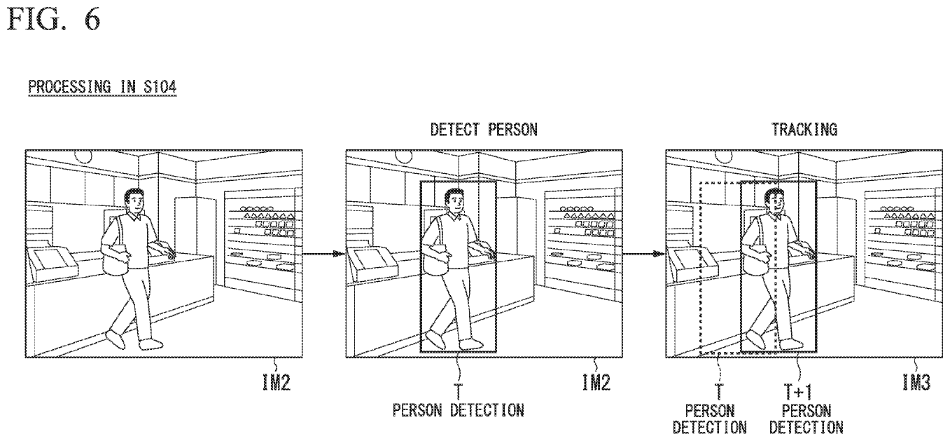

The processing for tracking the user in Step S102 will be described. FIG. 6 is a diagram showing the processing in which the recognizer 54 tracks the user (the processing in Step S104 in FIG. 4). The recognizer 54 detects the user in an image IM2 captured at a clock time T. The recognizer 54 detects the detected person in an image IM3 captured at a clock time T+1. The recognizer 54 specifies the position of the user at the clock time T+1 on the basis of the positions of the user at the clock time T and before the clock time T and the moving direction, and estimates a user who is present near the estimated position as a user who is a target to be tracked (tracking target). In a case in which the user can be specified, the tracking is regarded as having successfully been performed.

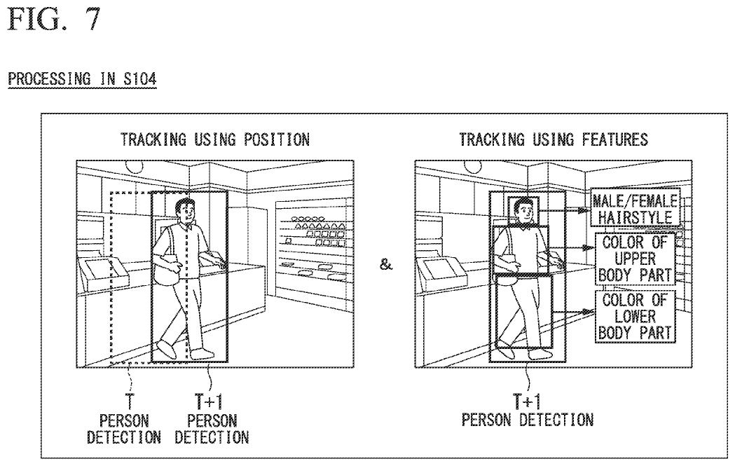

The recognizer 54 may track the user further using the features of the user in addition to the position of the user at the clock time T+1 as described above. FIG. 7 is a diagram showing tracking processing using the features. For example, the recognizer 54 estimates the position of the user at the clock time T+1, specifies the user who is present near the estimated position, and further extracts the features of the user. In a case in which the extracted features conform to the registered features by amounts equal to or greater than a threshold value, the control device 50 estimates that the specified user is a user as a tracking target and determines that the tracking has successfully been performed.

For example, even in a case in which the user as a tracking target overlaps or intersects with another person, the user can be more accurately tracked on the basis of a change in position of the user and the features of the user as described above.

### (Processing for Specifying User)

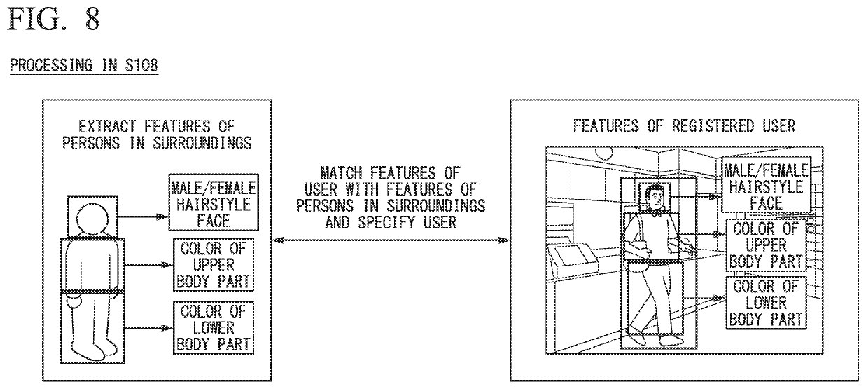

The processing for specifying the user in Step S106 will be described. In a case in which the tracking of the user has not successfully been performed, the recognizer 54 matches features of persons in the surroundings with features of the registered user and specifies the user as a tracking target as shown in FIG. 8. The recognizer 54 extracts features of each person included in the image, for example. The recognizer 54 matches the features of each person with the features of the registered user and specifies a person with features that conform to the features of the registered user by amounts equal to or greater than a threshold value. The recognizer 54 regards the specified user as a user who is a tracking target.

The recognizer 54 of the control device 50 can more accurately track the user through the aforementioned processing.

### [Processing Related to Tracking (Part 2)]

Although the aforementioned example has been described on the assumption that the user is a customer who has visited the shop, the following processing may be performed in a case in which the user is a shop staff member or a facility staff member (a healthcare person in a facility, for example).

(Processing for Registering User)

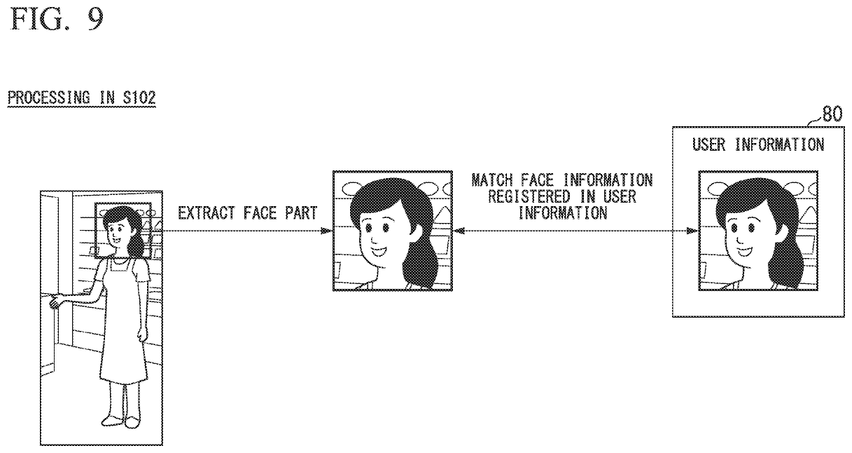

The processing for registering the user in Step S102 may be performed as follows. FIG. 9 is a diagram showing another example of the processing (the processing in Step S102 in FIG. 4) in which the recognizer 54 tracks the user. The recognizer 54 extracts features of face parts of the person from the captured image. The recognizer 54 matches the extracted features of the face parts with the features of the face parts of the user as a tracking target registered in advance in the user information 80, and in a case in which these features conform to each other, determines that the person included in the image is the user as a tracking target.

(Processing for Specifying User)

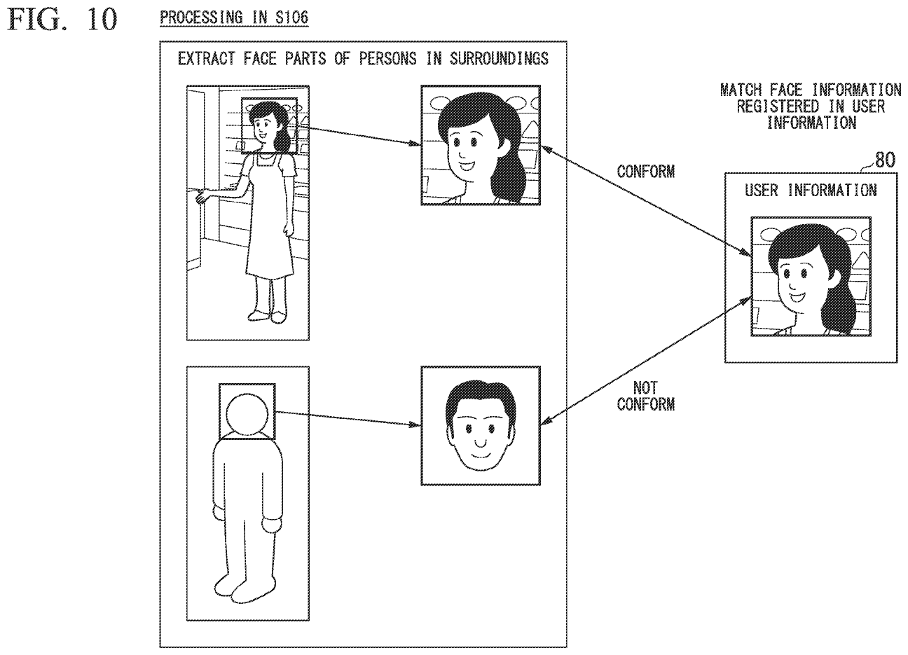

The processing for specifying the user in Step S106 may be performed as follows. In a case in which the tracking of the user has not successfully been performed, the recognizer 54 matches features of the faces of the persons in the surroundings with the features of the registered user and specifies the person with the features that conform to the features by amounts equal to or greater than a threshold value as the user who is a tracking target as shown in FIG. 10.

As described above, the recognizer 54 of the control device 50 can more accurately track the user.

[Processing Related to Action Control]

FIG. 11 is a flowchart showing an example of an action control processing flow. The processing is processing executed after the processing in Step S104 in FIG. 4. The control device 50 recognizes a gesture of the user (Step S200) and controls an action of the mobile object 10 on the basis of the recognized gesture (Step S202). Next, the control device 50 determines whether or not to end the service (Step S204). In a case in which the service is not to be ended, the processing returns to Step S102 in FIG. 4 to continue the tracking. In a case in which the service is to be ended, the control device 50 deletes registration information registered in relation to the user, such as the features of the user (Step S206). In this manner, one routine of the flowchart ends.

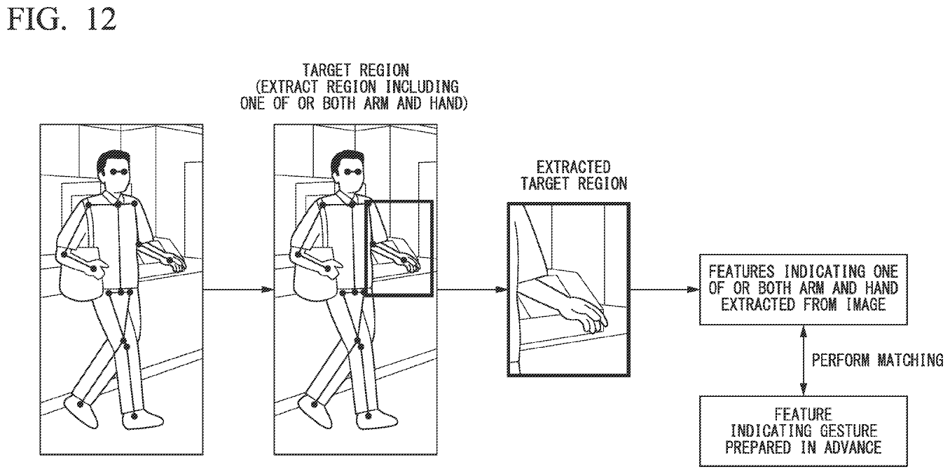

The processing in Step S200 will be described. FIG. 12 is a diagram showing processing for recognizing a gesture. The control device 50 extracts a region (hereinafter, a target region) including one of or both arms and hands from the result of the skeleton processing and extracts features indicating a state of one of or both the arms and the hands in the extracted target region. The control device 50 specifies the features to be matched with the features indicating the aforementioned state from the features included in the gesture information 74. The control device 50 causes the mobile object 10 to execute operations of the mobile object 10 associated with the specified features in the gesture information 74.

### (Processing for Recognizing Gesture)

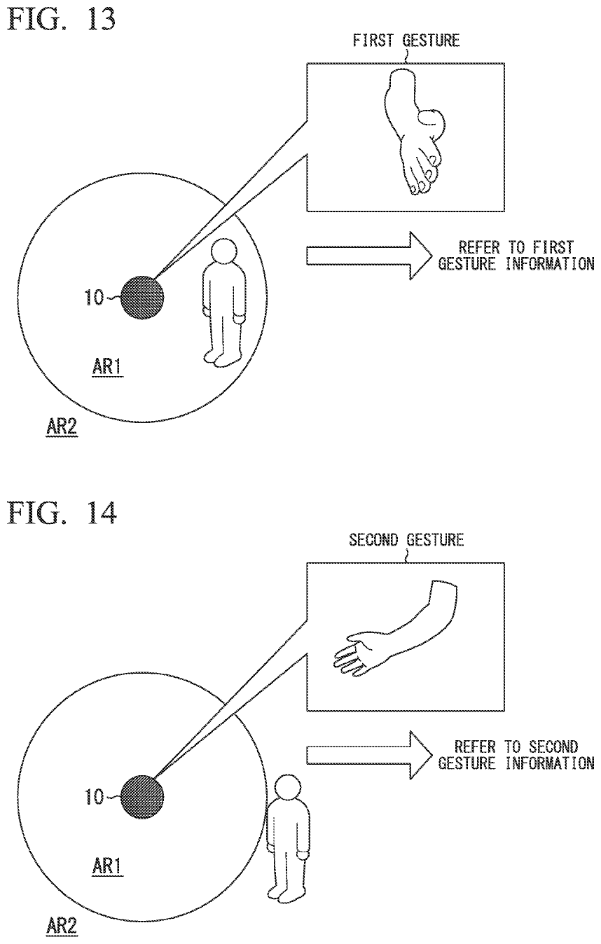

The control device 50 determines which of first gesture information 76 and second gesture information 78 in the gesture information 74 is to be referred to on the basis of the relative positions of the mobile object 10 and the user. In a case in which the user is not separated from the mobile object by a predetermined distance as shown in FIG. 13, in other words, in a case in which the user is present in a first region AR1 set with reference to the mobile object 10, the control device 50 determines whether or not the user is performing the same gesture as the gesture included in the first gesture information 76. In a case in which the user is separated from the mobile object by the predetermined distance as shown in FIG. 14, in other words, in a case in which the user is present in a second region set with reference to the mobile object 10 (in a case in which the user is not present in the first region AR1), the control device 50 determines whether the user is performing the same gesture as the gesture included in the second gesture information 78.

The first gesture included in the first gesture information 76 is a gesture using a hand without using an arm, and the second gesture included in the second gesture information 78 is a gesture using the arm (the arm between the elbow and the hand) and the hand. The first gesture may be any body action such as a body motion, a hand motion, or the like that is smaller than the second gesture. The small body motion means that the body motion of the first gesture is smaller than the body motion of the second gesture in a case in which the mobile object 10 is caused to perform a certain operation (the same operation such as moving straight ahead). For example, the first motion may be a gesture using a hand or fingers, and the second gesture may be a gesture using an arm. For example, the first motion may be a gesture using a feet below a knee, and the second gesture may be a gesture using a lower body. For example, the first motion may be a gesture using a hand, a foot, or the like, and the second gesture may be a gesture using the entire body, such as jumping.

If the camera 22 of the mobile object 10 images the user who is present in the first region AR1, the arm part is unlikely to be captured in the image, and a hand or fingers are captured in the image as shown in FIG. 13. The first region AR1 is a region in which it is not possible or difficult for the recognizer 54 to recognize the arm of the user from the image capturing the user who is present in the first region AR1. If the camera 22 of the mobile object 10 images the user who is present in the second region AR2, the arm part is captured in the image as shown in FIG. 14. Therefore, the recognizer 54 recognizes the gesture using the first gesture information 76 in a case in which the user is present in the first region AR1, or the recognizer 54 recognizes the gesture using the second gesture information 78 in a case in which the user is present in the second region AR2 as described above, and it is thus possible to more accurately recognize the gesture of the user. Hereinafter, the second gesture and the first gesture will be described in this order.

### [Gestures and Actions Included in Second Gesture Information]

Hereinafter, a front direction (forward direction) of the user will be referred to as an X direction, a direction intersecting the front direction will be referred to as a Y direction, and a direction that intersects the X direction and the Y direction and is opposite to the vertical direction will be referred to as a Z direction. Although the following description will be given using the right arm and the right hand in regard to gestures for moving the mobile object 10, equivalent motions work as gestures for moving the mobile object 10 even in a case in which the left arm and the left hand are used.

### (Second Gesture A)

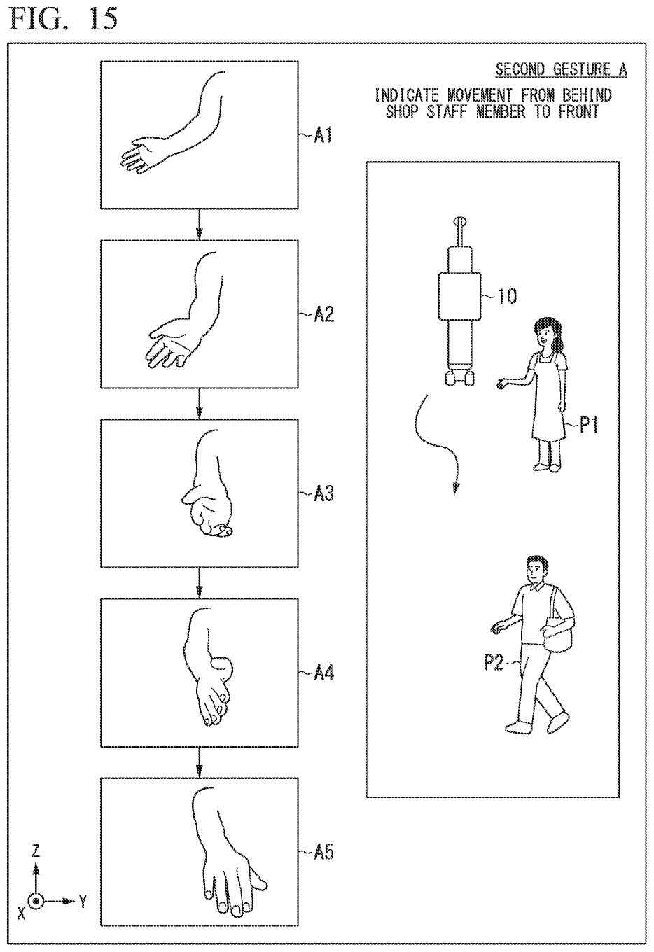

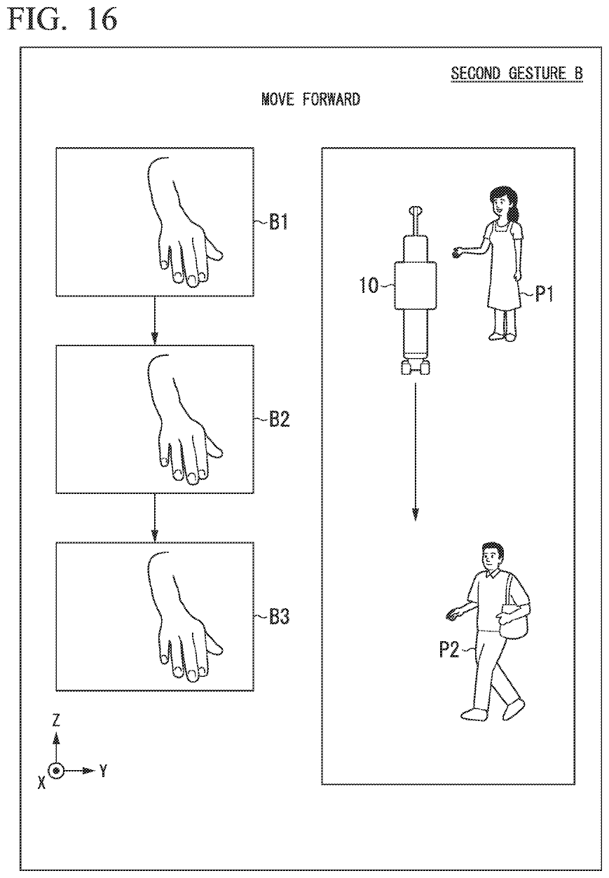

FIG. 15 is a diagram showing a second gesture A. The left side of FIG. 15 shows a gesture, and the right side of FIG. 15 shows an action of the mobile object 10 corresponding to the gesture (the same applies to the following diagrams). The following description will be given on the assumption that the gesture is performed by a user P1 (shop staff member), for example (the same applies to the following drawings). P2 in the drawing is a customer.

The gesture A is a gesture of the user pushing the arm and the hand in front of the body from a part near the body to cause the mobile object 10 located behind the user to move to the front of the user. The hand is turned with the arm and the hand kept in parallel with substantially the negative Y direction and with the thumb directed to the positive Z-axis direction (Al in the drawing), the joint of a shoulder or an elbow is moved in this state to move the hand in the positive X direction (A2 in the drawing), and the finger tips are further kept in parallel with the positive X direction (A3 in the drawing). In this state, the palm is directed to the positive Z direction. Then, the hand and the arm are turned such that the palm is directed to the negative Z direction in a state in which the finger tips are substantially parallel with the X direction (A4 and A5 in the drawing). In a case in which the second gesture A is performed, the mobile object 10 located behind the user P moves to the front of the user P1.

### (Second Gesture B)

FIG. 16 is a diagram showing a second gesture B. The second gesture B is a gesture of stretching the arm and the hand forward to move the mobile object 10 forward. The arm and the hand are stretched in a direction parallel to a direction in which the mobile object 10 is caused to move (the positive X direction, for example) in a state in which the palm is directed to the negative Z direction and the arm and the hand are stretched (from B1 to B3 in FIG. 16). In a case in which the second gesture B is performed, the mobile object 10 moves in the direction indicated by the finger tips.

### (Second Gesture C)

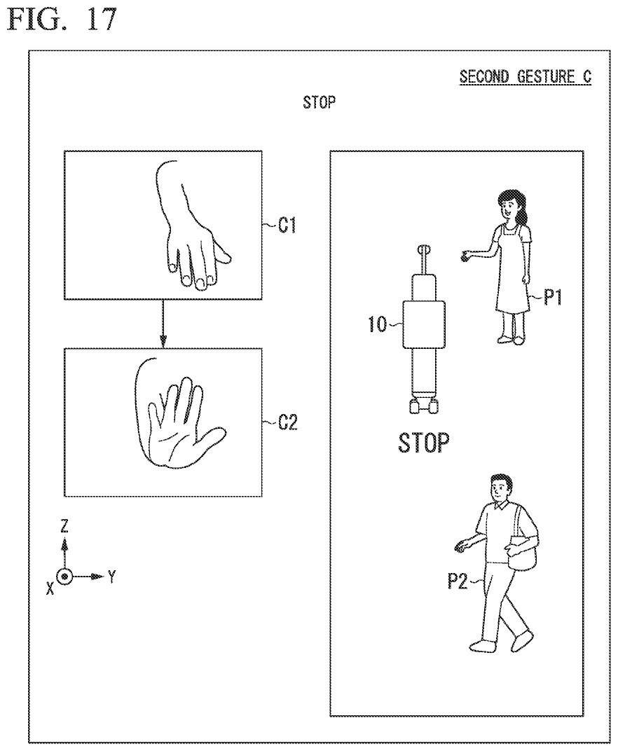

FIG. 17 is a diagram showing a second gesture C. The second gesture C is a gesture to cause the palm to face the X direction out of the arm and the hand stretched forward to stop the mobile object 10 moving forward (C1 and C2 in the drawing). In a case in which the second gesture C is performed, the mobile object 10 is brought into a stopped state from the state in which the mobile object 10 moves forward.

### (Second Gesture D)

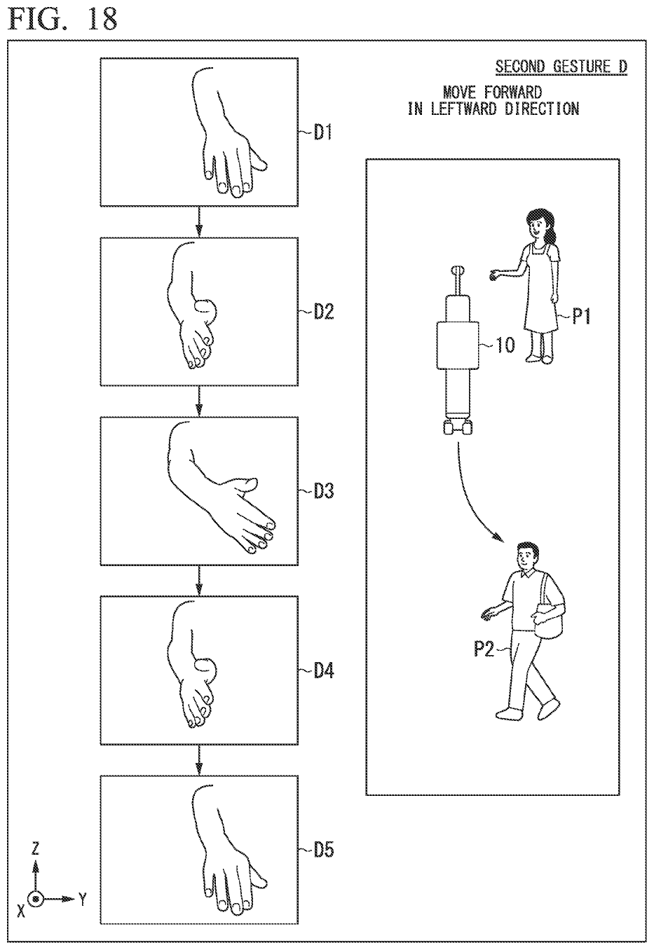

FIG. 18 is a diagram showing a second gesture D. The second gesture D is a motion of moving the arm and the hand in the leftward direction to move the mobile object 10 in the leftward direction. An operation of turning the palm by about 90 degrees in the clockwise direction from the state in which the arm and the hand are stretched forward (D1 in the drawing) to direct the thumb in the positive Z direction (D2 in the drawing), shaking the arm and the hand in the positive Y direction starting from this state, and returning the arm and the hand to the start point is repeated (D3 and D4 in the drawing). In a case in which the second gesture D is performed, the mobile object 10 moves in the leftward direction. If the arm and the hand are returned to the aforementioned state of D1 in the drawing, then the mobile object 10 moves forward without moving in the leftward direction.

### (Second Gesture E)

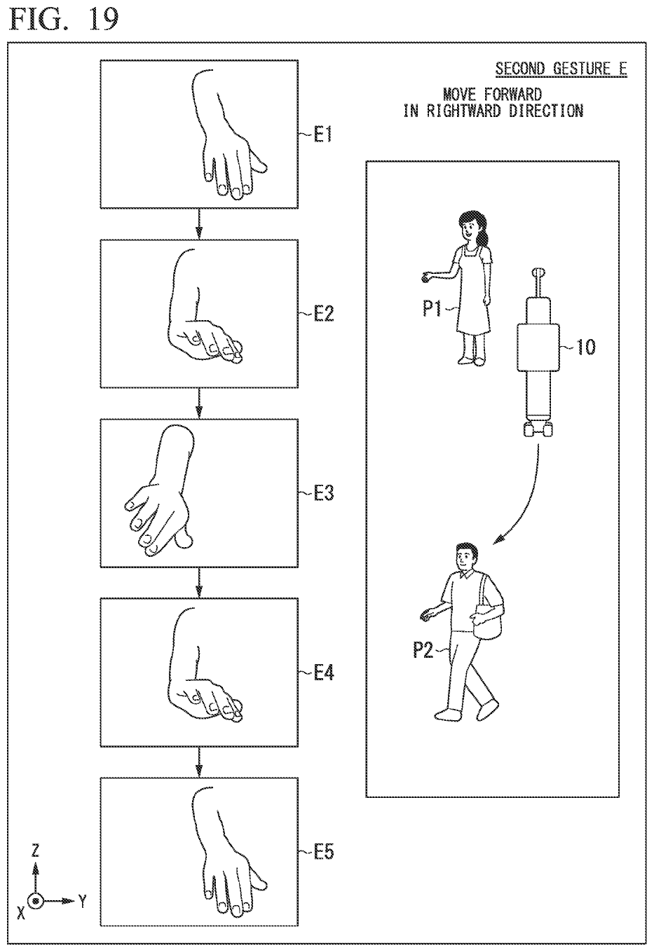

FIG. 19 is a diagram showing a second gesture E. The second gesture E is a motion of moving the arm and the hand in the rightward direction to move the mobile object 10 in the rightward direction. An operation of turning the palm in the counterclockwise direction from the state in which the arm and the hand are stretched forward (E1 in the drawing) to direct the thumb to the ground direction (E2 in the drawing), shaking the arm and the hand in the negative Y direction starting from this state, and returning the arm and the hand to the start point is repeated (E3 and E4 in the drawing). In a case in which the second gesture E is performed, the mobile object 10 moves in the rightward direction. If the arm and the hand are returned to the aforementioned state of E1 in the drawing, then the mobile object 10 moves forward without moving in the rightward direction.

### (Second Gesture F)

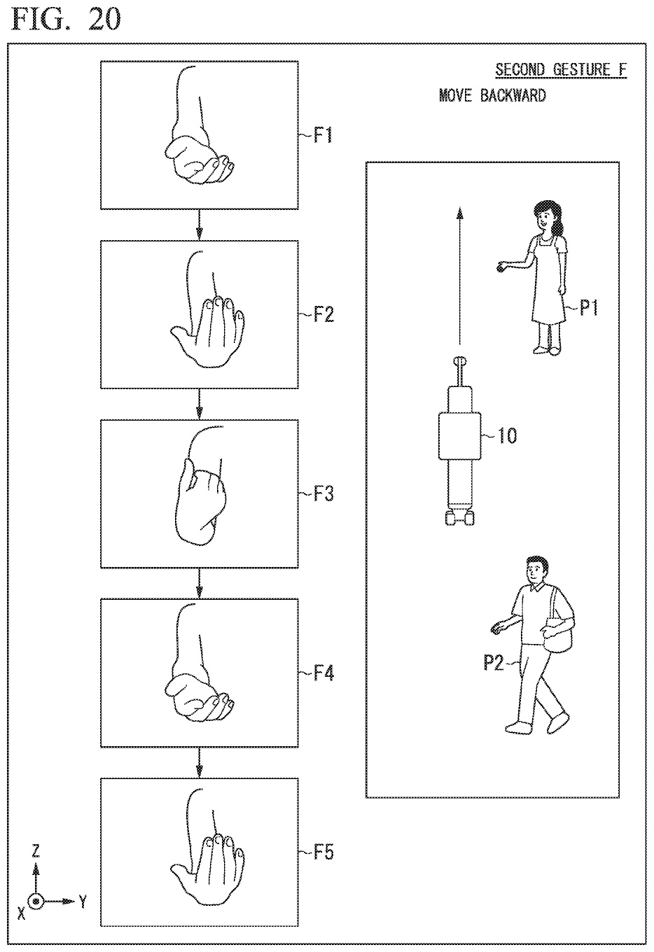

FIG. 20 is a diagram showing a second gesture F. The second gesture F is a motion of beckoning to move the mobile object 10 backward. An operation of directing the palm to the positive Z direction (F1 in the drawing) and moving the arm or the wrist to direct finger tips to the direction of the user is repeated (F2 to F5 in the drawing). In a case in which the second gesture F is performed, the mobile object 10 moves backward.

### (Second Gesture G)

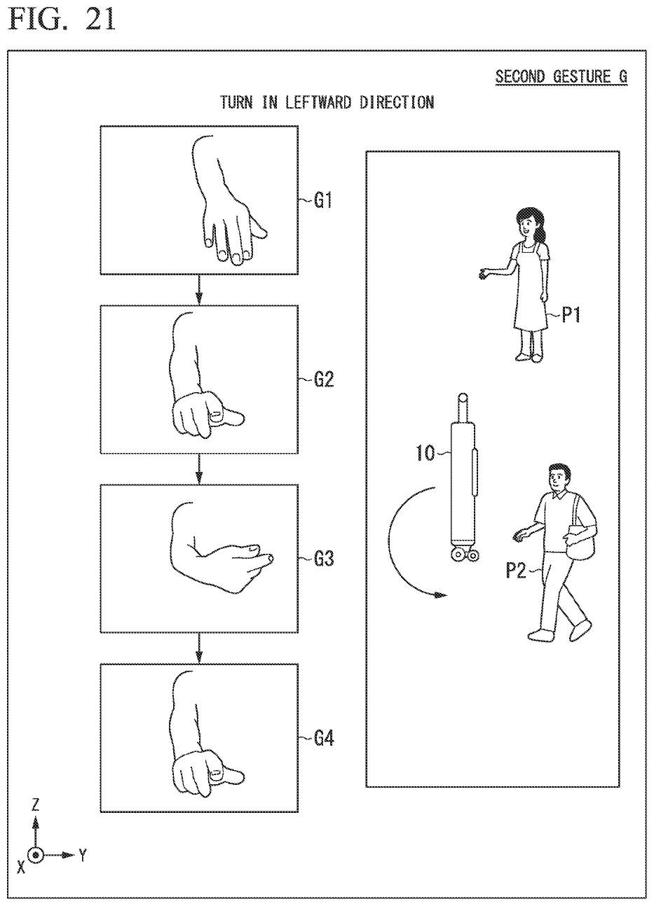

FIG. 21 is a diagram showing a second gesture G. The second gesture G is a motion of stretching an index finger (or a predetermined finger) and turning the stretched finger in the leftward direction to turn the mobile object 10 in the leftward direction. The palm is directed to the negative Z direction (G1 in the drawing), a state in which the index finger is stretched and the other fingers are slightly bent (folded state) is achieved (G2 in the drawing), the wrist or the arm is moved to direct the finger tips to the positive Y direction, and the arm and the hand are returned to the state of G1 in the drawing (G3 and G4 in the drawing). In a case in which the second gesture G is performed, the mobile object 10 turns in the leftward direction.

### (Second Gesture H)

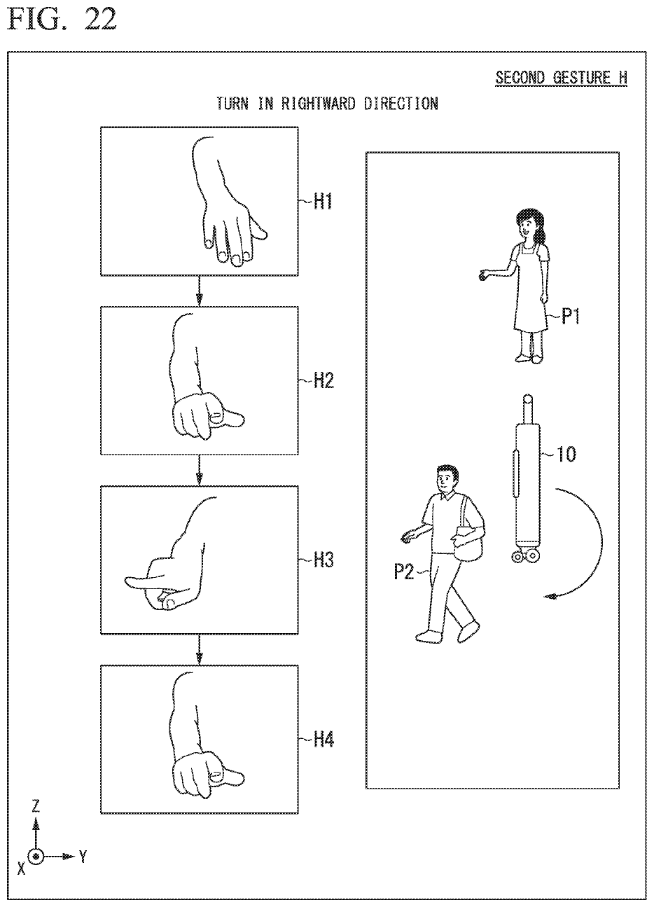

FIG. 22 is a diagram showing a second gesture H. The second gesture H is a motion of stretching the index finger (or a predetermined finger) and turning the stretched finger in the rightward direction to turn the mobile object 10 in the rightward direction. The palm is directed to the negative Z direction (H1 in the drawing), a state in which the index finger is stretched and the other fingers are slightly bent (folded state) is achieved (H2 in the drawing), the wrist or the arm is moved to direct the finger tips to the negative Y direction, and the arm and the hand are returned to the state of H1 in the drawing (H3 and H4 in the drawing). In a case in which the second gesture H is performed, the mobile object 10 turns in the rightward direction.

[Gestures included in First Gesture Information]

### (First Gesture a)

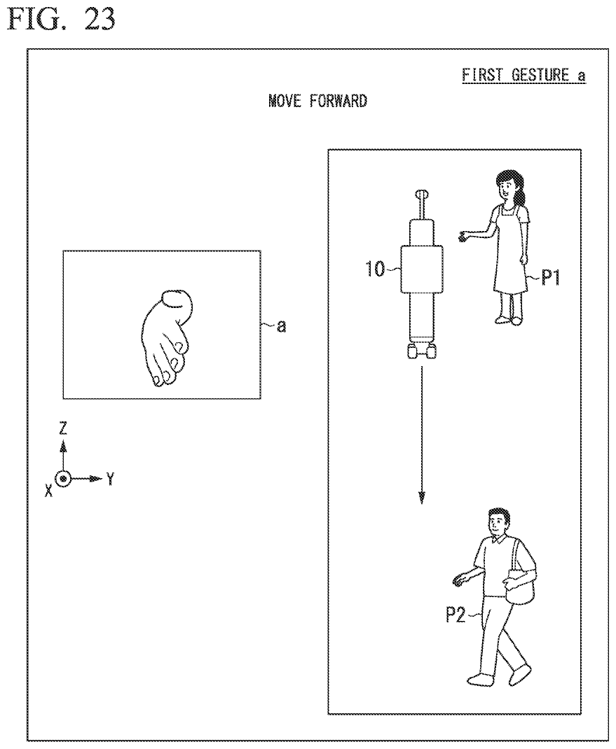

FIG. 23 is a diagram showing a first gesture a. The first gesture a is a gesture of stretching the hand forward to move the mobile object 10 forward. The thumb is directed to the positive Z direction such that the back of the hand is parallel with the Z direction (a in the drawing). In a case in which the first gesture a is performed, the mobile object 10 moves in the direction indicated by the finger tips.

### (First Gesture b)

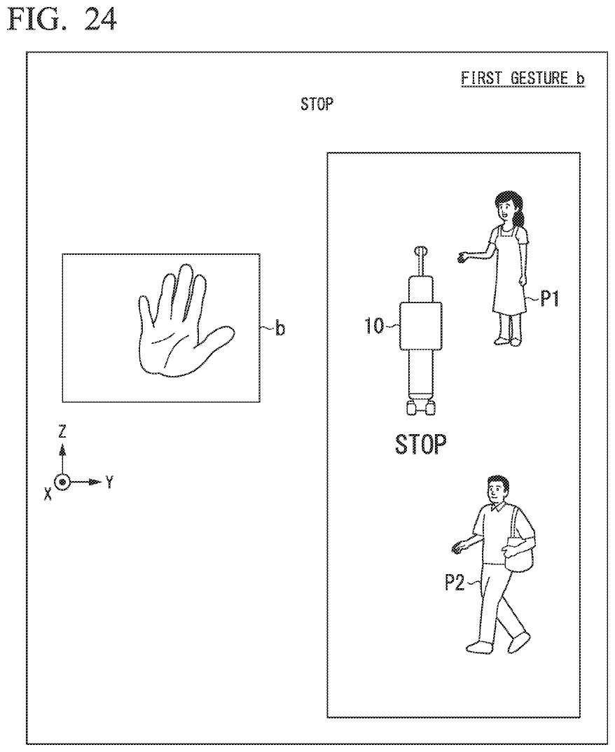

FIG. 24 is a diagram showing a first gesture b. The first gesture b is a gesture of causing the palm to face the X direction to stop the mobile object 10 moving forward (b in the drawing). In a case in which the first gesture b is performed, the mobile object 10 is brought into a stop state from the state in which the mobile object 10 moves forward.

### (First Gesture c)

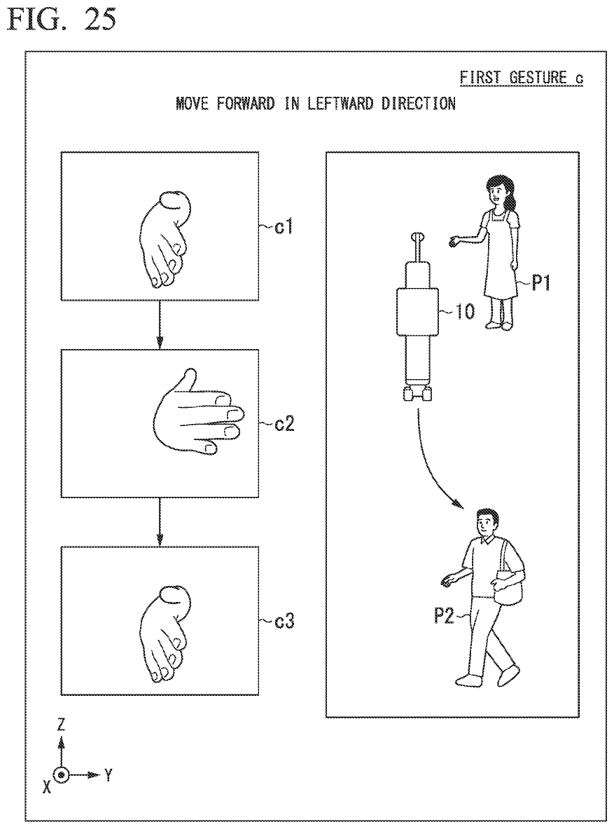

FIG. 25 is a diagram showing a first gesture c. The first gesture c is a motion of moving the hand in the leftward direction to move the mobile object 10 in the leftward direction. An operation of directing the finger tips to the positive Y side starting from the state in which the hand is stretched forward as shown by a in FIG. 23 (c1 in the drawing) and returning to the start point is repeated (c2 and c3 in the drawing). In a case in which the first gesture c is performed, the mobile object 10 moves in the leftward direction.

### (First Gesture d)

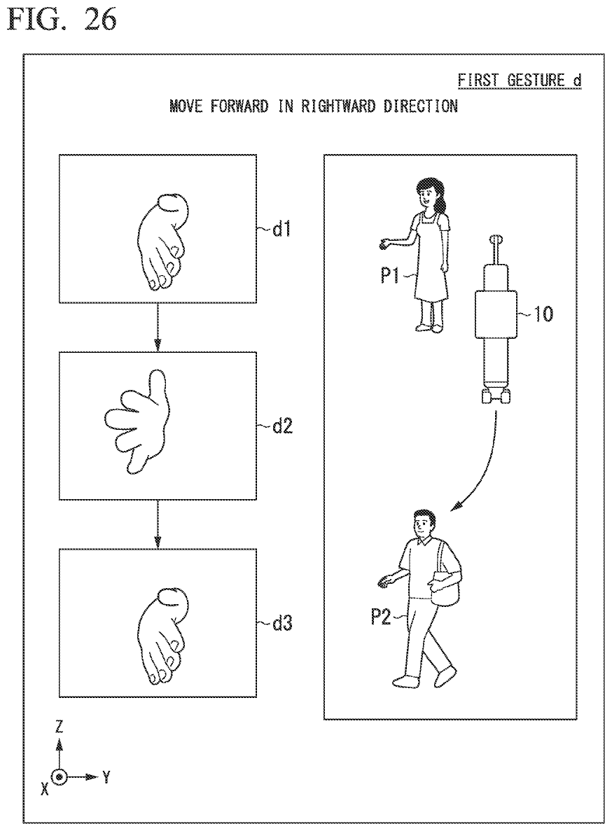

FIG. 26 is a diagram showing a first gesture d. The first gesture d is a motion of moving the hand in the rightward direction to move the mobile object 10 in the rightward direction. An operation of directing the finger tips to the negative Y side starting from the state in which the hand is stretched forward as shown by a in FIG. 23 (d1 in the drawing) and returning to the start point is repeated (d2 and d3 in the drawing). In a case in which the first gesture d is performed, the mobile object 10 moves in the rightward direction.

### (First Gesture e)

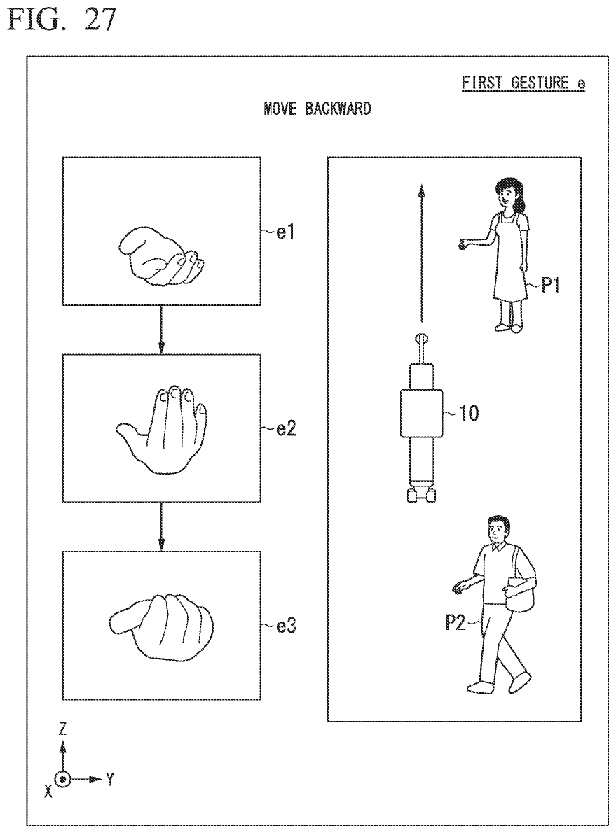

FIG. 27 is a diagram showing a first gesture e. The first gesture e is a motion of beckoning with the finger tips to move the mobile object 10 backward. An operation of directing the palm to the positive Z direction (e1 in the drawing) and moving the finger tips such that the finger tips are directed to the direction of the user (such that the finger tips are caused to approach the palm) is repeated (e2 and e3 in the drawing). In a case in which the first gesture e is performed, the mobile object 10 moves backward.

### (First Gesture f)

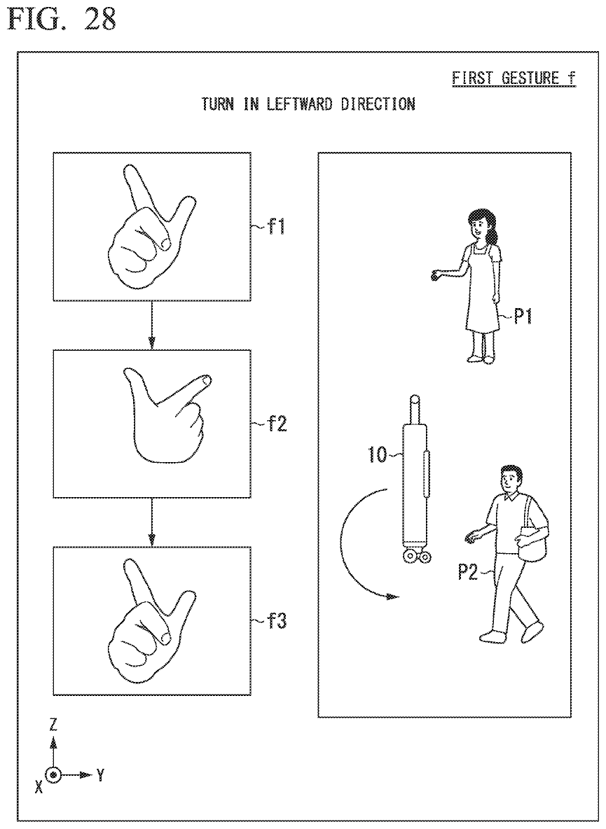

FIG. 28 is a diagram showing a first gesture f. The first gesture f is a motion of stretching the index finger and the thumb (or a predetermined finger) and turning the stretched fingers in the leftward direction to turn the mobile object 10 in the leftward direction. The palm is directed to the positive X direction, a state in which the index finger and the thumb are stretched and the other fingers are slightly bent (folded state) is achieved (f1 in the drawing), the palm is directed to the negative X direction, and the hand is then turned to direct the back of the hand to the positive X direction (f2 in the drawing). Then, the turned hand is returned to the original state (f3 in the drawing). In a case in which the first gesture f is performed, the mobile object 10 turns in the leftward direction.

### (First Gesture g)

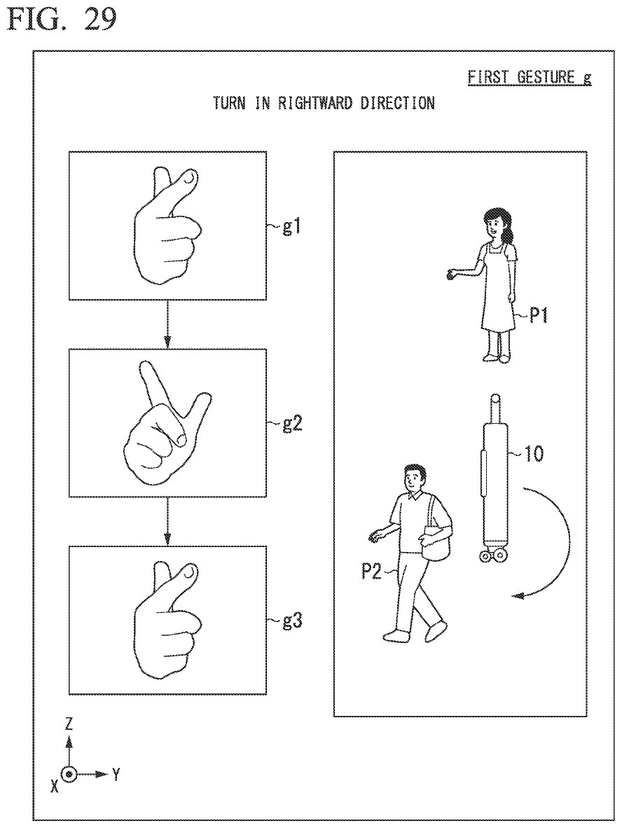

FIG. 29 is a diagram showing a first gesture g. The first gesture g is a motion of stretching the index finger and the thumb (or a predetermined finger) and turning the stretched fingers in the rightward direction to turn the mobile object 10 in the rightward direction. A state in which the index finger and the thumb are stretched and the other fingers are slightly bent (folded state) is achieved, and the index finger is directed to the positive X direction or an intermediate direction between the positive X direction and the positive Y direction (g1 in the drawing). In this state, the index finger is turned in the positive Z direction or an intermediate direction between the positive Z direction and the negative Y direction (g2 in the drawing). Then, the turned hand is returned to the original state (g3 in the drawing). In a case in which the first gesture g is performed, the mobile object 10 turns in the rightward direction.

### [Flowchart]

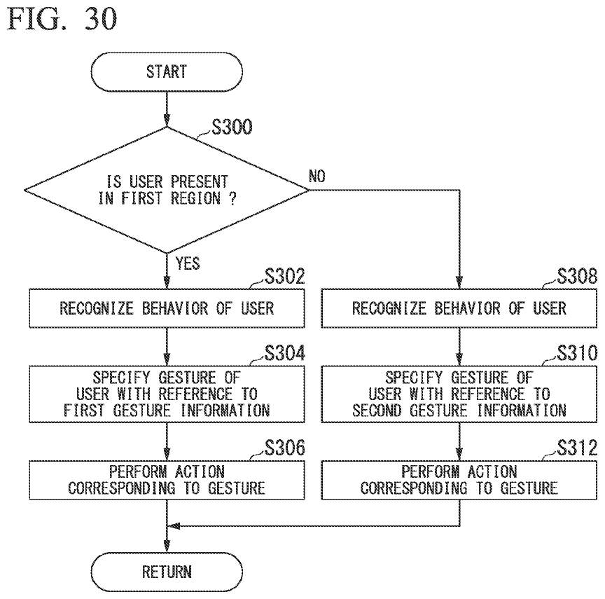

FIG. 30 is a flowchart showing an example of processing in which the control device 50 recognizes a gesture. First, the control device 50 determines whether or not the user is present in the first region (Step S300). In a case in which the user is present in the first region, the control device 50 recognizes a behavior of the user on the basis of acquired images (Step S302). The behavior is a motion of the user recognized from the images temporally successively acquired.

Next, the control device 50 refers to the first gesture information 76 and specifies a gesture that conforms to the behavior recognized in Step 302 (Step S304). In a case in which the gesture that conforms to the behavior recognized in Step S302 is not included in the first gesture information 76, it is determined that the gesture for controlling a motion of the mobile object 10 is not performed. Next, the control device 50 performs an action corresponding to the specified gesture (Step S306).

In a case in which the user is not present in the first region (in a case in which the user is present in the second region), the control device 50 recognizes a behavior of the user on the basis of an acquired image (Step S308) and refers to the second gesture information 78 and specifies a gesture that conforms to the behavior recognized in Step S308 (Step S310). Next, the control device 50 performs an action corresponding to the specified gesture (Step S312). In this manner, the processing of one routine of the flowchart ends.

For example, the recognizer 54 may recognize the gesture of the user who is being tracked and may not perform processing of recognizing gestures of persons who are not being tracked in the aforementioned processing. In this manner, the control device 50 can perform the control of the mobile object on the basis of the gesture of the user who is being tracked with a reduced processing load.

As described above, the control device 50 can more accurately recognize the gesture of the user and cause the mobile object 10 to operate in accordance with user's intention by switching the gesture to be recognized on the basis of the region where the user is present. As a result, user convenience is improved.

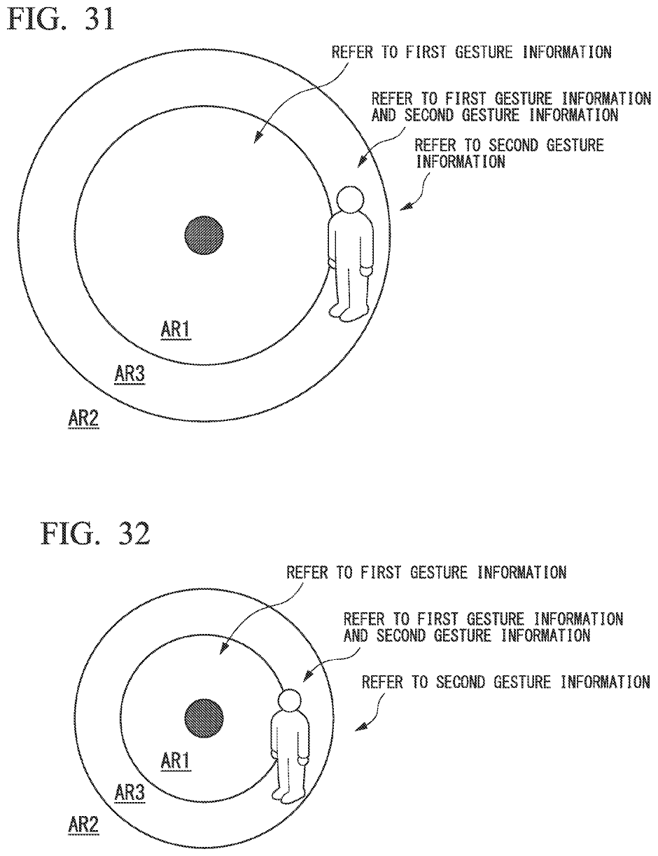

The control device 50 may recognize the gesture with reference to the first gesture information 76 and the second gesture information 78 in the third region AR3 as shown in FIG. 31. In FIG. 31, the third region AR3 is a region between an outer edge of the first region AR1 and a position outside the first region AR1 and at a predetermined distance from the outer edge. The second region AR2 is a region outside the third region AR3.

In a case in which the user is present in the first region AR1, the recognizer 54 recognizes a gesture with reference to the first gesture information 76. In a case in which the user is present in the second region AR2, the recognizer 54 recognizes a gesture with reference to the first gesture information 76 and the second gesture information 78. In other words, the recognizer 54 determines whether or not the user is performing the first gesture included in the first gesture information 76 or the second gesture included in the second gesture information 78. In a case in which the user is performing the first gesture or the second gesture in the third region AR3, the control device 50 controls the mobile object 10 on the basis of the operation associated with the first gesture or the second gesture of the user. In a case in which the user is present in the second region AR2, the recognizer 54 recognizes the gesture with reference to the second gesture information 78.

The third region AR3 may be a region between the outer edge of the first region AR1 and the position inside the first region AR1 and at a predetermined distance from the outer edge as shown in FIG. 32. The third region AR3 may be a region sectioned between a boundary inside the outer edge of the first region AR1 and at a predetermined distance from the outer edge and a boundary outside the outer edge of the first region AR1 and at a predetermined distance from the outer edge (a region obtained by combining the third region AR3 in FIG. 31 and the third region AR3 in FIG. 32 may be the third region).

In a case in which both the first gesture and the second gesture are recognized in the third region AR3, for example, the first gesture may be employed with higher priority than the second gesture. Priority means that priority is placed on the operation of the first gesture or the second gesture is not taken into consideration in a case in which the operation of the mobile object 10 indicated by the first gesture and the operation of the mobile object 10 indicated by the second gesture are different from each other, for example. In a case in which the user is unintentionally moving the arm, the motion may be recognized as the second gesture, and this is because the possibility that the small gesture using the hand or the fingers is unintentionally performed by the user is low while the possibility that the user is moving the hand or the fingers with intention of performing a gesture is high. In this manner, it is possible to more accurately recognize a user's intention by placing priority on the first gesture.

Although the above example has been described on the assumption that the recognizer 54 recognizes a body motion of the user on the basis of a plurality of images successively captured (a plurality of images captured at predetermined intervals or a video), alternatively (or additionally), the recognizer 54 may recognize a body motion of the user on the basis of one image. In this case, the recognizer 54 compares features indicating a body motion of the user included in one image with features included in the first gesture information 76 or the second gesture information 78, for example, and recognizes that the user is performing a gesture with features with a high degree of conformity or a degree equal to or greater than a predetermined degree.

In a case in which the recognizer 54 recognizes a body motion of the user using an image captured by a camera (imaging device) provided at a position different from the mobile object 10 in the above example, the first region is a region within a range of a predetermined distance from the imaging device that captures the image, and the second region is a region set at a position further than the predetermined distance from the imaging device.

Although the above example has been described on the assumption that the second region is a region that is located at a position further than the first region, alternatively, the region may be set at a position different from the first region and the second region. For example, the first region may be a region set in a first direction, and the second region may be a region set in a direction different from the first direction.

According to the first embodiment described above, the control device 50 can more accurately recognize the gesture of the user and cause the mobile object 10 to appropriately operate by the control device 50 switching the gestures to be recognized in accordance with the position of the user relative to the mobile object. As a result, user inconvenience is improved.

### Second Embodiment

Hereinafter, a second embodiment will be described. The main body 20 of the mobile object 10 according to the second embodiment includes a first camera (first imager) and a second camera (second imager) and recognizes a gesture using images captured by these cameras. Hereinafter, differences from the first embodiment will be mainly described.

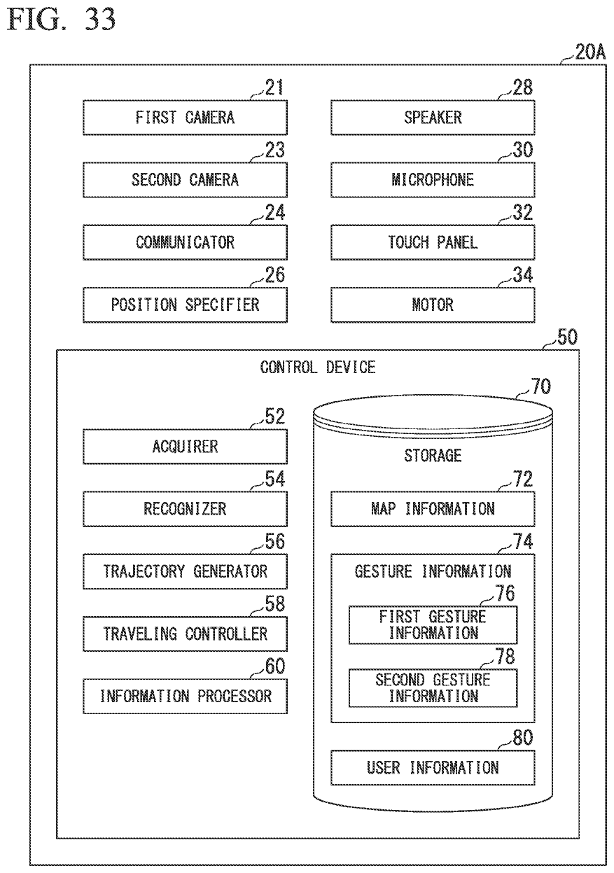

FIG. 33 is a diagram showing an example of functional configurations in a main body 20A of the mobile object 10 according to the second embodiment. The main body 20A includes a first camera 21 and a second camera 23 instead of the camera 22. The first camera 21 is a camera that is similar to the camera 22. The second camera 23 is a camera that images the user who remotely operates the mobile object 10. The second camera 23 is a camera capturing an image for recognizing a gesture of the user. The remote operation is performed by a gesture. The second camera 23 can control the imaging direction using a machine mechanism, for example. The second camera 23 captures an image around the user as a tracking target at the center. The information processor 60 controls the machine mechanism to direct the imaging direction of the second camera 23 to the user as the tracking target, for example.

The recognizer 54 attempts processing of recognizing a gesture of the user on the basis of a first image captured by the first camera 21 and a second image captured by the second camera 23. The recognizer 54 places priority on a result of the recognition based on the second image (second recognition result) than a result of the recognition based on the first image (first recognition result). The trajectory generator 56 generates a trajectory on the basis of the surrounding situation obtained from the first image and an operation associated with the recognized gesture. The traveling controller 58 controls the mobile object 10 on the basis of the trajectory generated by the trajectory generator 56.

### [Flowchart]

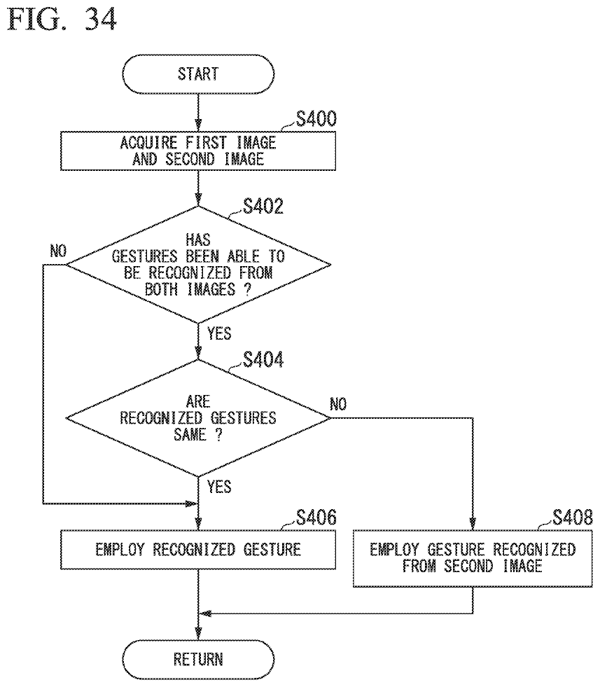

FIG. 34 is a flowchart showing an example of a processing flow executed by the control device 50 according to the second embodiment. First, the acquirer 52 of the control device 50 acquires the first image and the second image (Step S400). Next, the recognizer 54 attempts processing of recognizing a gesture in each of the first image and the second image and determines whether or not gestures have been able to be recognized from both the images (Step S402). The first gesture information 76 is referred to in a case in which the user is present in the first region in the processing, or the second gesture information 78 is referred to in a case in which the user is present outside the first region.

In a case in which the gesture has been able to be recognized in both the images, the recognizer 54 determines whether the recognized gestures are the same (Step S404). In a case in which the recognized gestures are the same, the recognizer 54 employs the recognized gesture (Step S406). In a case in which the recognized gestures are not the same, the recognizer 54 employs the gesture recognized from the second image (Step S408). In this manner, the second recognition result is employed with higher priority than the first recognition result.

In a case in which gestures have not been able to be recognized in both the images in the processing in Step S402, the recognizer 54 employs a gesture that can be recognized (a gesture that can be recognized in the first image or a gesture that can be recognized in the second image) (Step S406). In a case in which the user is present in the first region and a gesture of the user cannot be recognized on the basis of the first image captured by the first camera 21, for example, the recognizer 54 refers to the first gesture information 76 and recognizes a gesture of the user on the basis of the second image captured by the second camera 23. Then, the mobile object 10 is controlled to perform the action in accordance with the employed gesture. In this manner, the processing of one routine of the flowchart ends.

The control device 50 can more accurately recognize the gesture of the user through the aforementioned processing.

In the second embodiment, the first gesture information 76 or the second gesture information 78 may be referred to, or gesture information (information in which features of gestures and actions of the mobile object 10 are associated) that is different from the first gesture information 76 and the second gesture information 78 (the position of the user is not taken into consideration, for example) may be referred to, regardless of the position of the user.

According to the second embodiment described above, the control device 50 can more accurately recognize the gesture through recognition of the gesture using images captured by two or more cameras and can control the mobile object 10 on the basis of the result of the recognition. As a result, it is possible to improve user convenience.

### [Modifications of Second Gesture]

The second gesture may take the following aspects instead of the aforementioned second gesture. For example, the second gesture may be a gesture that is performed by an upper arm and does not take motions of the palm into consideration, for example. In this manner, the control device 50 can more accurately recognize the second gesture even if the second gesture is performed at a far distance. Although examples will be given below, aspects different from these may be employed.

### (Second Gesture G)

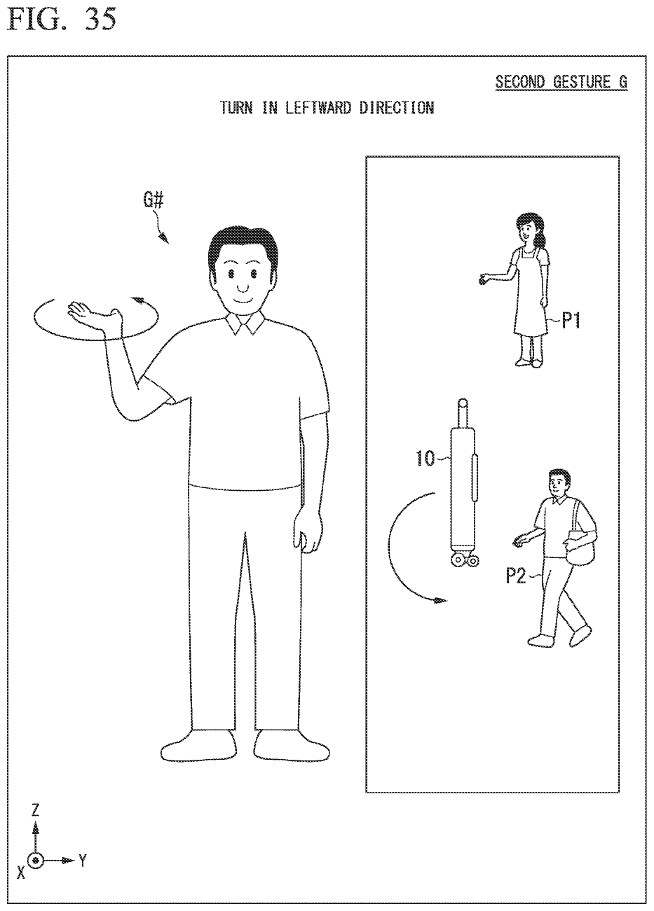

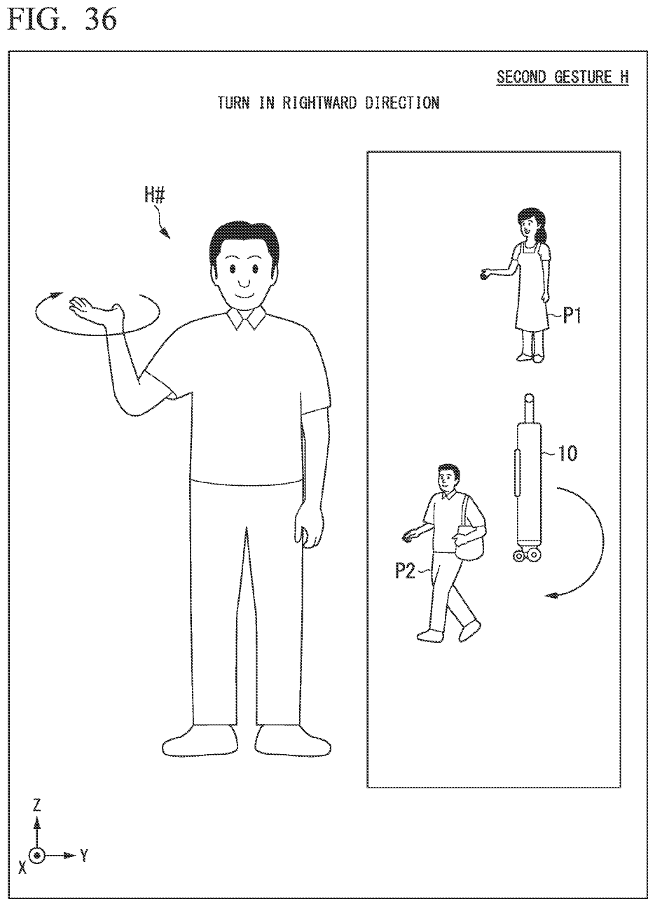

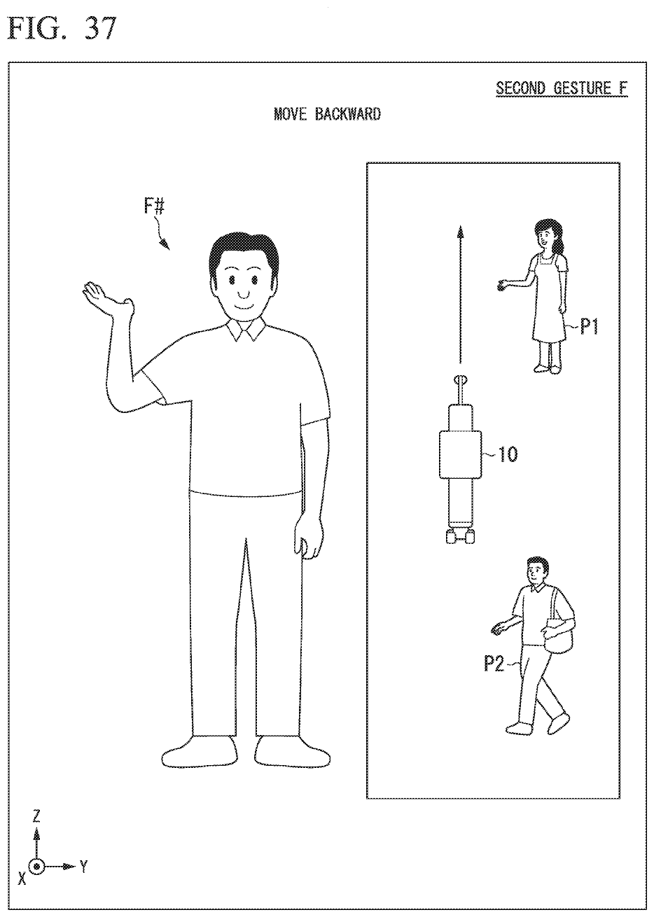

FIG. 35 is a diagram showing a modification example of a second gesture G. The second gesture G is a motion (G# in the drawing) of bending the elbow, directing the palm to the upper direction, and turning the upper arm in the leftward direction to turn the mobile object 10 in the leftward direction. In a case in which the second gesture G is performed, the mobile object 10 turns in the leftward direction. (Second Gesture H) FIG. 36 is a diagram showing a modification example of the second gesture H.

The second gesture H is a motion (H# in the drawing) of bending the elbow, directing the palm to the upper direction, and turning the upper arm in the rightward direction to turn the mobile object 10 in the rightward direction. In a case in which the second gesture H is performed, the mobile object 10 turns in the rightward direction.

### (Second Gesture F)

FIG. 37 is a diagram showing a modification example of the second gesture F. The second gesture F is a motion (F# in the drawing) of bending the elbow and directing the palm to the upper side to move the mobile object 10 backward. In a case in which the second gesture F is performed, the mobile object 10 moves backward.

### (Second Gesture FR)

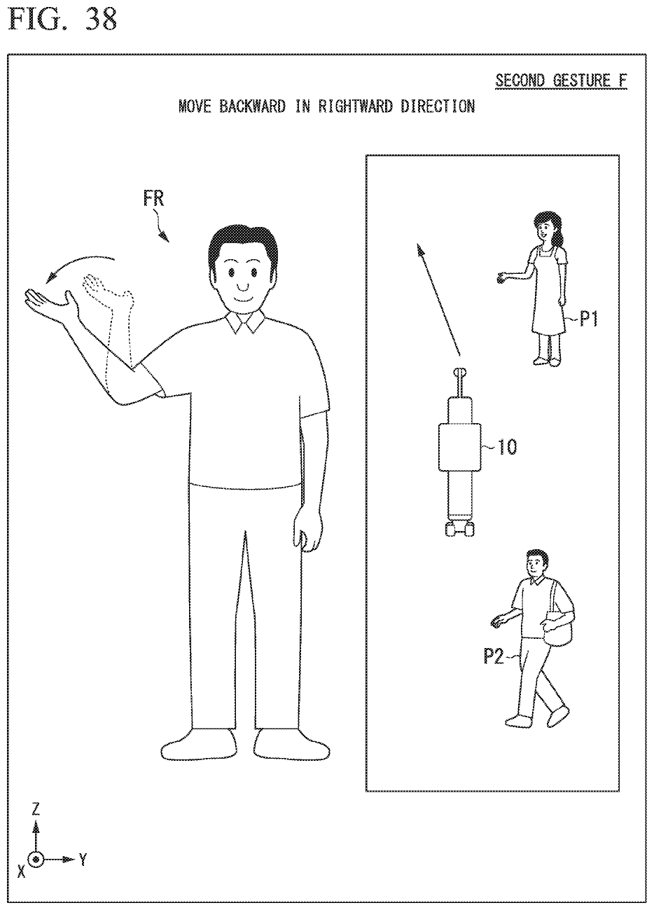

FIG. 38 is a diagram showing a second gesture FR. The second gesture FR is a motion (FR in the drawing) of bending the elbow, directing the palm to the upper side, and determining the amount of movement by which the mobile object 10 moves in the rightward direction depending on the degree of inclination of the upper arm in the rightward direction to move the mobile object 10 backward while moving the mobile object 10 in the rightward direction. In a case in which the second gesture FR is performed, the mobile object 10 moves backward while moving in the rightward direction in accordance with the degree of inclination of the upper arm in the rightward direction.

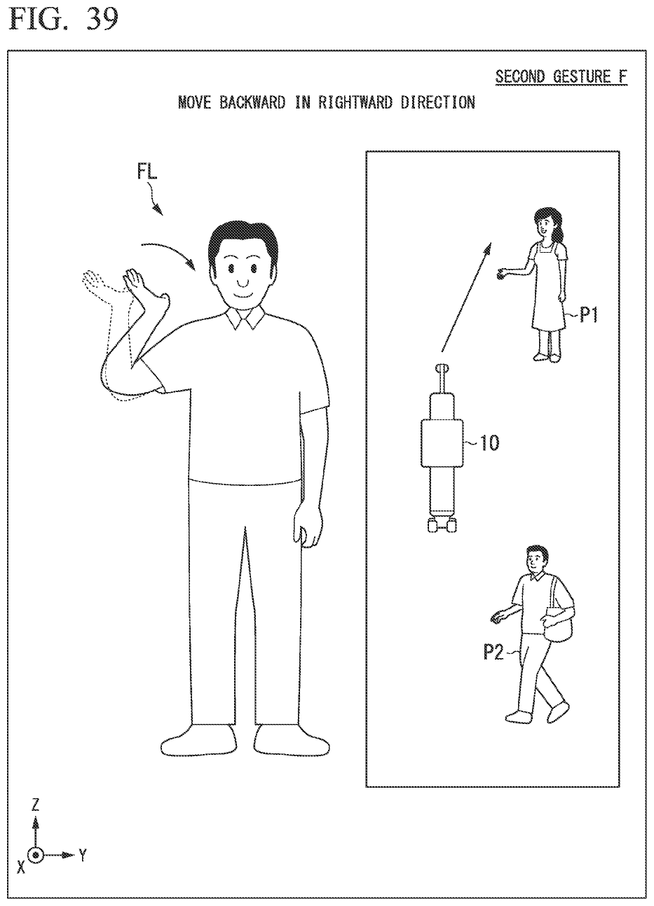

FIG. 39 is a diagram showing a second gesture FL. The second gesture FL is a motion (FL in the drawing) of bending the elbow, directing the palm to the upper side, and determining the amount of movement by which the mobile object 10 moves in the leftward direction in accordance with the degree of inclination of the upper arm in the leftward direction to move the mobile object 10 backward while moving the mobile object 10 in the leftward direction. In a case in which the second gesture FL is performed, the mobile object 10 moves backward while moving in the leftward direction in accordance with the degree of inclination of the upper arm in the leftward direction.

As described above, the control device 50 controls the mobile object 10 on the basis of the second gesture performed by the upper arm. Even in a case in which a person who is present at a far location performs the second gesture, for example, the control device 50 can more accurately recognize the second gesture and control the mobile object 10 in accordance with the person's intention.

The aforementioned embodiments can be expressed as follows.

A gesture recognition apparatus including:

a storage device configured to store instructions; and

one or more processors,

in which the one or more processors execute the instructions stored in the storage device to
acquire an image capturing a user,
recognize a region where the user is present when the image is captured, and
in a case in which the user is present in a first region when the image is captured, recognize a gesture of the user on the basis of the image and first information for recognizing a gesture of the user, and
in a case in which the user is present in a second region when the image is captured, recognize a gesture of the user on the basis of a plurality of the images temporally successively captured and second information for recognizing the gesture of the user.

The embodiments described above can be expressed as follows.

A gesture recognition apparatus including:

a first imager configured to image surroundings of a mobile object; and

a second imager configured to image a user who remotely operates the mobile object;

a storage device storing instructions; and

one or more processors,

in which the one or more processors execute the instructions stored in the storage device to
attempt processing for recognizing a gesture of the user on the basis of a first image captured by the first imager and a second image captured by the second imager and employ, with higher priority, a result of the recognition based on the second image than a result of the recognition based on the first image, and
control the mobile object on the basis of a surrounding situation obtained from the image captured by the first imager and an operation associated with the gesture recognized by the recognizer.

The embodiments described above can be expressed as follows.

A gesture recognition apparatus including:

a first imager configured to image surroundings of a mobile object;

a second imager configured to image a user who remotely operates the mobile object;

a storage device storing instructions; and

one or more processors,

in which the one or more processors execute the instructions stored in the storage device to
recognize a gesture of the user on the basis of a second image captured by the second imager with reference to the first information in a case in which the user is present in a first region and a gesture of the user is not able to be recognized on the basis of a first image captured by the first imager, and
control the mobile object on the basis of the image captured by the first imager in accordance with the recognized gesture.

Although the forms to perform the invention have been described using the embodiments, the invention is not limited to such embodiments at all, and various modifications and replacements can be made without departing from the gist of the invention.

What is claimed is:

1. A gesture recognition system comprising:
a storage device configured to store instructions; and
one or more processors,
wherein the one or more processors execute the instructions stored in the storage device to
acquire an image capturing a user,
recognize a region where the user is present when the image is captured, and
in a case in which the user is present in a first region when the image is captured, recognize a gesture of the user on the basis of the image and first information for recognizing the gesture of the user, and
in a case in which the user is present in a second region when the image is captured, recognize a gesture of the user on the basis of the image and second information for recognizing the gesture of the user.

2. The gesture recognition system according to claim 1,
wherein the first region is a region within a range of a predetermined distance from an imaging device that captures the image, and
the second region is a region set at a position further than the predetermined distance from the imaging device.

3. The gesture recognition system according to claim 1, wherein the first information is information for recognizing a gesture that does not include a motion of an arm, include a motion of the hand or fingers, and is achieved by a motion of the hand or the fingers.

4. The gesture recognition system according to claim 1, wherein the second information is information for recognizing a gesture that includes a motion of an arm.

5. The gesture recognition system according to claim 4, wherein the first region is a region in which it is not possible or difficult to recognize the motion of the arm of the user from the image capturing the user who is present in the first region through execution of the instructions by the one or more processors.

6. The gesture recognition system according to claim 1,
wherein the one or more processors execute the instructions to
recognize a gesture of the user on the basis of the image, the first information, and the second information in a case in which the user is present in a third region which is located across the first region and a second region that is outside the first region and is adjacent to the first region or a third region located between the first region and a second region that is located further than the first region when the image is captured.

7. The gesture recognition system according to claim 6,
wherein the one or more processors execute the instructions to
recognize a gesture of the user by placing higher priority on a result of recognition based on the image and the first information than on a result of recognition based on the image and the second information in a case in which the gesture of the user is recognized on the basis of the image, the first information, and the second information.

8. A mobile object comprising:
the gesture recognition system according to claim 1.

9. The mobile object according to claim 8, further comprising:
a storage device storing reference information in which a gesture of the user and an operation of the mobile object are associated; and
a controller configured to control the mobile object on the basis of the operation of the mobile object associated with the gesture of the user with reference to the reference information.

10. The mobile object according to claim 9, further comprising:
a first imager configured to image surroundings of the mobile object; and
a second imager configured to image a user who remotely operates the mobile object,
wherein the one or more processors execute the instructions to
attempt processing for recognizing a gesture of the user on the basis of a first image captured by the first imager and a second image captured by the second imager and employ, with higher priority, a result of the recognition based on the second image than a result of the recognition on the basis of the first image, and
cause the mobile object to be controlled on the basis of a surrounding situation obtained from the image captured by the first imager and the operation associated with the gesture recognized by the recognizer.

11. The mobile object according to claim 8, further comprising:
a first imager configured to image surroundings of the mobile object; and
a second imager configured to image a user who remotely operates the mobile object,
wherein the one or more processors execute the instructions to
recognize a gesture of the user on the basis of a second image captured by the second imager with reference to the first information in a case in which the user is present in a first region and it is not possible to recognize the gesture of the user on the basis of a first image captured by the first imager, and
cause the mobile object to be controlled on the basis of an image captured by the first imager in accordance with the recognized gesture.

12. The mobile object according to claim 8,
wherein the one or more processors execute the instructions to
track a user as a target on the basis of a captured image, recognize a gesture of the user who is being tracked, and not perform processing for recognizing gestures of persons who are not being tracked, and
control the mobile object on the basis of the gesture of the user who is being tracked.

13. A gesture recognition method comprising, by a computer:
acquiring an image capturing a user;
recognizing a region where the user is present when the image is captured; and
in a case in which the user is present in a first region when the image is captured, recognizing a gesture of the user on the basis of the image and first information for recognizing the gesture of the user; and
in a case in which the user is present in a second region when the image is captured, recognizing a gesture of the user on the basis of the image and second information for recognizing the gesture of the user.

14. A non-transitory computer storage medium storing instructions causing a computer to execute:
acquiring an image capturing a user;
recognizing a region where the user is present when the image is captured; and
in a case in which the user is present in a first region when the image is captured, recognizing a gesture of the user on the basis of the image and first information for recognizing the gesture of the user; and
in a case in which the user is present in a second region when the image is captured, recognizing a gesture of the user on the basis of the image and second information for recognizing the gesture of the user.
